(19) United States
(12) Patent Application Publication
(10) Pub. No.: US 2025/0356611 A1
(43) Pub. Date: Nov. 20, 2025

(54) IMPLEMENTING MACHINE-LEARNED MODELS DURING IMAGE ANALYSIS TO EVALUATE TEMPERATURES OF OBJECTS ASSOCIATED WITH A STRUCTURE

(71) Applicant: Fluke Corporation, Everett, WA (US)

(72) Inventors: Matthew F. Schmidt, River Falls, WI (US); Seyed Navid Roohani Isfahani, Seattle, WA (US); Nirav Narendra Dedhiya, Lynwood, WA (US)

(21) Appl. No.: 19/029,986

(22) Filed: Jan. 17, 2025

Related U.S. Application Data
(60) Provisional application No. 63/647,595, filed on May 14, 2024.

(51) Int. Cl. G06V 10/25; G01J 5/00; G01J 5/48; G06T 5/50; G06V 10/764; H04N 23/23

(52) U.S. Cl. CPC G06V 10/25; G01J 5/485; G06T 5/50; G06V 10/764; H04N 23/23; G01J 2005/0077; G06T 2207/20221; G06V 2201/07

(57) ABSTRACT

A method for analyzing images includes obtaining a visible light image which depicts a structure and a thermal image which depicts the structure, implementing one or more first machine-learned models to identify a class associated with the structure in the visible light image, based on the visible light image, implementing one or more second machine-learned models to identify one or more objects associated with the structure in the visible light image, based on the visible light image and the class associated with the structure, determining a temperature associated with each object among the one or more objects, based on the thermal image, evaluating for each object among the one or more objects, whether a temperature value associated with a respective object among the one or more objects satisfies a temperature criteria associated with the respective object, and providing an output based on the evaluating.

### CROSS-REFERENCE TO RELATED APPLICATIONS

This application claims priority to and the benefit of U.S. Provisional Application No. 63/647,595 filed on May 14, 2024, the contents of which are incorporated by reference herein in its entirety for all purposes.

### FIELD

The disclosure relates generally to image analysis. More particularly, the disclosure relates to analyzing visible light and/or thermal images using machine-learned models and other forms of artificial intelligence.

Current methods for performing thermal analysis of structures (e.g., electrical equipment and systems, mechanical equipment and systems, etc.) depicted in images can require technicians and engineers manually inspecting the images to identify issues such as overheating components that could indicate problems (e.g., electrical problems). This process is labor-intensive, requires expertise, and is inefficient, particularly when dealing with hundreds or thousands of images from facilities which are inspected.

### BACKGROUND

Various artificial Intelligence (AI) technologies exist which can be implemented to perform object detection, image classification, image similarity search, and optical character recognition (OCR).

### SUMMARY

Aspects and advantages of embodiments of the disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example aspects of the disclosure include a computer-implemented method to analyze images associated with a structure. The computer-implemented method includes obtaining, by a computing device comprising one or more processors, a visible light image which depicts a structure and a thermal image which depicts the structure; implementing, by the computing device, one or more first machine-learned models to identify a class associated with the structure in the visible light image, based on the visible light image; implementing, by the computing device, one or more second machine-learned models to identify one or more objects associated with the structure in the visible light image, based on the visible light image and the class associated with the structure; determining, by the computing device, a temperature associated with each object among the one or more objects, based on the thermal image; evaluating, by the computing device, for each object among the one or more objects, whether a temperature value associated with a respective object among the one or more objects satisfies a temperature criteria associated with the respective object; and providing, by the computing device, an output based on the evaluating.

Example aspects of the disclosure include a computing device comprising one or more memories configured to store instructions; and one or more processors configured to execute the instructions to perform operations. The operations can include: obtaining a visible light image which depicts a structure and a thermal image which depicts the structure, implementing one or more first machine-learned models to identify a class associated with the structure in the visible light image, based on the visible light image, implementing one or more second machine-learned models to identify one or more objects associated with the structure in the visible light image, based on the visible light image and the class associated with the structure, determining a temperature associated with each object among the one or more objects, based on the thermal image, evaluating for each object among the one or more objects, whether a temperature value associated with a respective object among the one or more objects satisfies a temperature criteria associated with the respective object, and providing an output based on the evaluating.

The computing device may be configured to execute instructions to perform operations associated with any of the other aspects and operations of the computer-implemented methods described herein.

Example aspects of the disclosure include a non-transitory computer readable medium storing instructions which, when executed by a processor, cause the processor to perform operations for analyzing images, the operations comprising: obtaining a visible light image which depicts a structure and a thermal image which depicts the structure, implementing one or more first machine-learned models to identify a class associated with the structure in the visible light image, based on the visible light image, implementing one or more second machine-learned models to identify one or more objects associated with the structure in the visible light image, based on the visible light image and the class associated with the structure, determining a temperature associated with each object among the one or more objects, based on the thermal image, evaluating for each object among the one or more objects, whether a temperature value associated with a respective object among the one or more objects satisfies a temperature criteria associated with the respective object, and providing an output based on the evaluating.

The non-transitory computer-readable medium may store additional instructions to execute any of the other aspects and operations of the computing devices, computing systems, and computer-implemented methods described herein.

Other example aspects of the disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the disclosure and, together with the description, help explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the disclosure.

FIG. 1B depicts a block diagram of an example data flow for generating project performance operations according to example embodiments of the disclosure.

FIGS. 2A through 2B are example user interface screens selecting images for evaluating temperatures of objects associated with a structure, according to example embodiments of the disclosure.

FIGS. 3A through 3B are example user interface screens for evaluating temperatures of objects associated with a structure, according to example embodiments of the disclosure.

FIGS. 4A through 4C are example user interface screens for analyzing a structure for evaluating temperatures of objects associated with a structure, according to example embodiments of the disclosure.

FIGS. 5A through 5B are example user interface screens for identifying objects for evaluating temperatures of objects associated with a structure, according to example embodiments of the disclosure.

FIGS. 6A through 6C are example user interface screens for identifying a plurality of objects for evaluating temperatures of objects associated with a structure, according to example embodiments of the disclosure.

FIG. 7 is an example computer-implemented method for evaluating temperatures of objects associated with a structure, according to example embodiments of the disclosure.

FIG. 8 is a flow chart diagram illustrating an example method for training a machine-learned model, according to example embodiments of the disclosure.

FIG. 9 is a block diagram of an example sequence processing model, according to example embodiments of the disclosure.

FIG. 10 is a block diagram of an example implementation of a multi-modal sequence processing model, according to example embodiments of the disclosure.

FIG. 11 is an example training flow for training a machine-learned model, according to example embodiments of the disclosure.

FIG. 12 is a block diagram of an example networked computing system, according to example embodiments of the disclosure.

Reference numerals that are repeated across plural figures are intended to identify the same features in various implementations.

### DETAILED DESCRIPTION

### Overview

Currently, technicians and engineers in the fields of industrial maintenance, building inspection, electrical/mechanical maintenance, etc. manually inspect thermal images of electrical, mechanical, or industrial equipment or systems to identify issues such as overheating components that could indicate electrical problems or other issues. This process is labor-intensive, requires expertise, and is inefficient, particularly when dealing with hundreds or thousands of images from facilities.

According to the methods and computing systems of the disclosure described herein, computer vision approaches are applied to automate the anomaly-detection process in thermal images. For example, the anomaly-detection process can be applied to electrical, mechanical, or industrial equipment or systems (e.g., electrical panels, the connection points where wires are attached to components like fuse blocks). The methods and computing systems of the disclosure described herein enable users to identify and focus on the most critical thermal-image-based anomalies with no or limited manual intervention needed. The application of computer vision techniques to anomaly-detection processes in thermal images is highly technically challenging. Therefore, a technical problem in the field of image analysis is the application of computer systems to automatically analyze images (e.g., thermal images) of electrical, mechanical, or industrial equipment or systems (e.g., electrical panels, such as combiner boxes found at solar farms).

An example technical solution implemented by the methods and computing systems of the disclosure described herein can include an integrated system that uses machine learning and object detection algorithms to identify different classes of structures and different objects (e.g., components and connection points) in visible light images. The methods and computing systems of the disclosure described herein can then correlate (map) these points with their counterparts in thermal images, for example using image registration algorithms. Anomalies or abnormalities can be detected based on various temperature criteria. For example, anomalies or abnormalities can be detected based on differences from a reference point, which could be an ambient temperature or a component-class-specific reference point. The methods and computing systems of the disclosure described herein can calculate a severity score for each image based on various ranking criteria (e.g., an aggregated anomaly severity likelihood of all components within that image and/or the severity score of the most severe component). The severity score can then be used to rank and prioritize images for review. Thus, the methods and computing systems of the disclosure described herein can prioritize and rank images based on the severity of the thermal anomalies detected, and notify or alert users accordingly, and/or control the electrical, mechanical, or industrial equipment or systems to prevent or mitigate damage.

The methods and computing systems of the disclosure described herein can offer significant value to users by saving time and reducing the need for expert analysis. With the automated detection and ranking of anomalies, the methods and computing systems of the disclosure described herein can enable both experts and less experienced users to efficiently review thermal images and identify maintenance needs. By prioritizing images with the highest likelihood of problems, the methods and computing systems of the disclosure described herein can ensure that critical issues are addressed promptly, preventing equipment failure and reducing downtime at industrial facilities. The flexibility to adjust weights and thresholds for different alert levels and objects further enhances the computing system's utility for users, allowing for customization based on specific requirements or preferences.

The methods and computing systems of the disclosure described herein implement one or more machine-learned models to detect components and/or connection points in images (e.g., visible light images) and can correlate them with thermal images (e.g., infrared images) using image registration methods. This automation reduces the need for manual marking and analysis, is more accurate, avoids human errors in identifying components or temperatures to analyze, etc., and can be applied to various mechanical, electrical, and industrial systems and structures (e.g., for inspecting electrical panels including solar farm combiner boxes).

Unlike existing methods which require a user to manually place markers (e.g., points, lines, boundary shapes such as boundary boxes, etc.) in thermal images, the methods and computing systems of the disclosure described herein implement one or more machine-learned models to detect and identify objects in images (e.g., in visible light images) to find components and then translate these findings to the thermal image space. This operation is beneficial for components that do not show up in thermal images due to a lack of thermal contrast.

The methods and computing systems of the disclosure described herein can compute a delta temperature, which can correspond to the difference between the maximum temperature of a component (or connection point) and a reference ambient temperature. The delta temperature can be compared to a reference delta temperature value, which can be user-defined, a default value, or a value associated with the particular type of component or structure. The delta temperature can correspond to a difference between a maximum temperature value of the component and an ambient temperature value. The ambient temperature value can correspond to a lowest maximum component temperature, a statistically calculated value, a user-defined value, a default value, etc. In some implementations, the ambient temperature value corresponds to a temperature determined based on statistical calculations applied to the thermal image data including median, average, and 1st, 2nd, 3rd, and 4th quantile temperatures, etc. In some implementations, the ambient temperature value can be measured by a temperature sensor connected to the computing system (e.g. the image capturer) that measurers the ambient temperature in the vicinity of the objects being imaged. Accordingly, the method for determining the delta temperature value can provide a flexible way to assess temperature anomalies.

The methods and computing systems of the disclosure described herein can compute a severity or priority score for each image based on individual and/or aggregated temperature differences (delta temperatures) and alert levels for individual components. These scores can be used to rank images by the likelihood of anomalies, streamlining the review process for users by prioritizing images that require immediate attention, thereby decreasing downtime of systems or increasing uptime of systems, preventing damage to components or systems, etc. The computing systems and methods described herein can compute a severity or priority score for each object in an image based on temperature information (e.g., actual temperature values and/or delta temperature values) and alert levels for individual components. For example, a high severity alert may be output if any pixel in an image that is associated with part of an object is above a threshold value (e.g., 100° C.) and/or if any pixel in the image that is associated with part of the object is more than a threshold amount (e.g., 50° C.) above an ambient temperature value. The severity value for an object might also be calculated based on where the pixels are found within the object. For instance, pixels associated with a boundary region of an object might have a different temperature threshold than pixels from the interior of the object. For example, different threshold values may be implemented due to other considerations including wires going to/from a component which can cross the boundary region of the component's bounding box. The severity or priority scores can be used to rank components by the likelihood of anomalies, streamlining the review process for users by prioritizing components that require immediate attention, thereby decreasing downtime of components or systems or increasing uptime of components or systems, preventing damage to components or systems, etc.

The methods and computing systems of the disclosure described herein can enable users to customize the weights assigned to different alert levels or objects, which can adjust the severity score and the ranking of images. This level of customization provides users with the ability to tailor the analysis to specific needs or preferences based on different types of components or objects and issues present in different types of structures or systems.

The methods and computing systems of the disclosure described herein can detect anomalies at the component level, as well as at the subcomponent level or keypoint level (e.g., connection points within a fuse block), providing a more detailed analysis in the context of thermal image analysis.

The methods and computing systems of the disclosure described herein provide flexibility through the implementation of a user interface, enabling users to enter or adjust various parameters, such as ambient temperature values and weights for alert levels, which add aspects of interactivity and customization to the image analysis process. The user interface also enables the user to adjust and/or correct images and object classes and bounding shapes, enabling the capture of data that can be used to retrain and improve the machine-learned models.

With reference now to the drawings, example embodiments of the disclosure will be discussed in further detail.

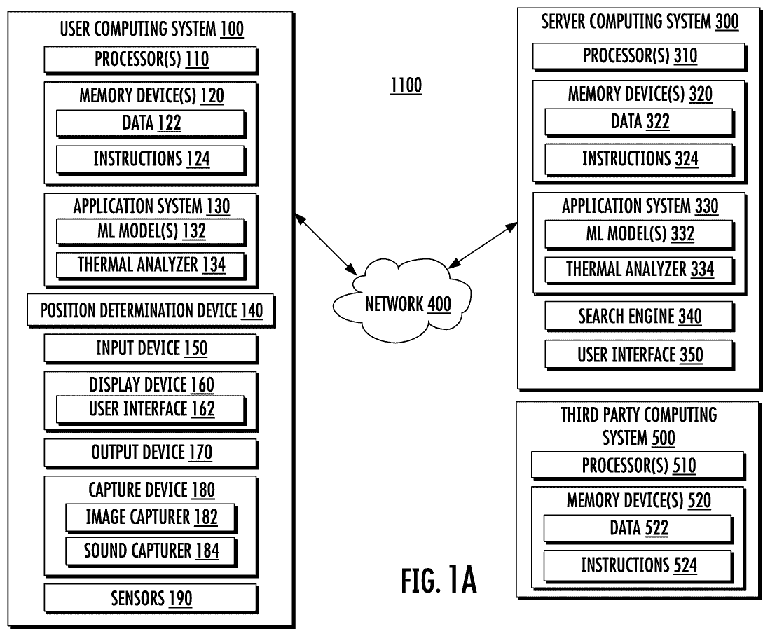

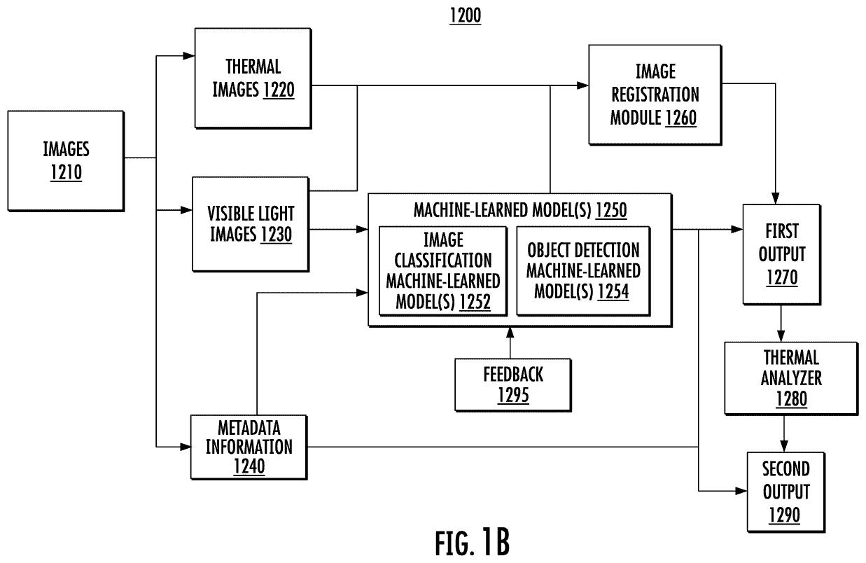

FIG. 1A depicts a block diagram of an example computing system 1100 according to example embodiments of the disclosure. The computing system 1100 includes a user computing system 100, a server computing system 300, and/or a third party computing system 500 that are communicatively coupled over a network 400.

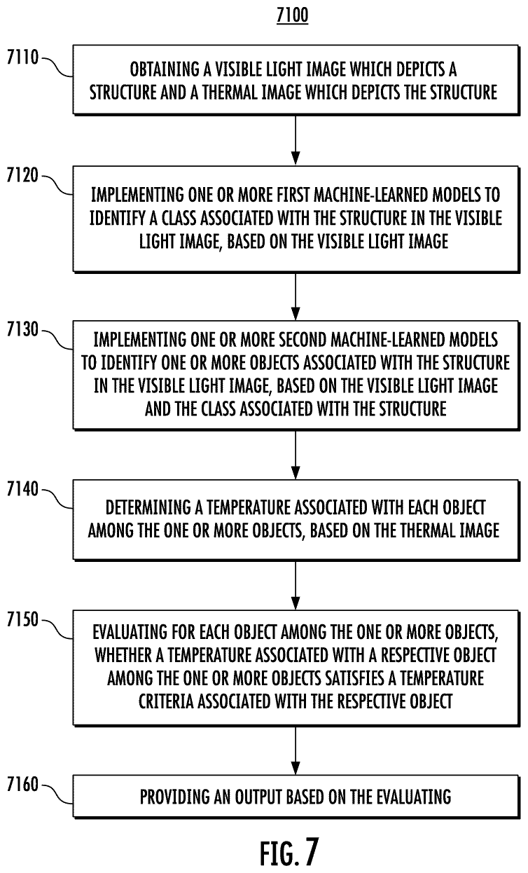

The user computing system 100 can include any type of computing device, such as, for example, a personal computing device (e.g., laptop or desktop), a mobile computing device (e.g., smartphone or tablet), a gaming console or controller, a wearable computing device (e.g., augmented-reality goggles), an embedded computing device, or any other type of computing device. In some implementations, the user computing system 100 can be realized by a single computing device or can be realized by a plurality of computing devices. For example, the user computing system 100 can include a first computing device (e.g., a smartphone, wearable computing device, etc.) to capture images of an inspection site and/or structure and a second computing device (e.g., a laptop computer, a desktop computer, etc.) to receive the images and to analyze the images. In some implementations, the user computing system 100 can include a first computing device (e.g., a smartphone, wearable computing device, etc.) to capture images of an inspection site and/or structure and to upload the images to the server computing system 300 which is configured to analyze the images according to the methods as described herein. For example, the user computing system 100 can correspond to and implement some or all of the operations implemented by computing system 1200 described herein with respect to FIG. 1B and some or all of the operations of the computer-implemented method of FIG. 7.

The server computing system 300 can include or otherwise be implemented by one or more server computing devices. In instances in which the server computing system 300 includes plural server computing devices, such server computing devices can operate according to sequential computing architectures, parallel computing architectures, or some combination thereof. For example, the server computing system 300 can correspond to and implement some or all of the operations implemented by computing system 1200 described herein with respect to FIG. 1B and some or all of the operations of the computer-implemented method of FIG. 7.

The network 400 may include any type of communications network including a wired or wireless network, or a combination thereof. The network 400 may include a local area network (LAN), wireless local area network (WLAN), wide area network (WAN), personal area network (PAN), virtual private network (VPN), or the like. For example, wireless communication between elements of the example embodiments may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and the like. For example, wired communication between elements of the example embodiments may be performed via a pair cable, a coaxial cable, an optical fiber cable, an Ethernet cable, and the like. Communication over the network 400 can use a wide variety of communication protocols (e.g., TCP/IP, HTTP, SMTP, FTP), encodings or formats (e.g., HTML, XML), and/or protection schemes (e.g., VPN, secure HTTP, SSL).

As will be explained in more detail below, in some implementations the user computing system 100 and/or server computing system 300 may form part of an application system which can provide a tool via one or more machine-learned models for users to perform a thermal analysis of images of an inspection site and/or structure so as to detect anomalies or irregularities of objects or objects' subcomponents depicted in the images.

The user computing system 100 includes one or more processors 110, one or more memory devices 120, an application system 130, a position determination device 140, an input device 150, a display device 160, an output device 170, a capture device 180, and one or more sensors 190. The server computing system 300 may include one or more processors 310, one or more memory devices 320, an application system 330, a search engine 340, and a user interface 350. The third party computing system 500 may include one or more processors 510 and one or more memory devices 520.

For example, the one or more processors 110, 310, 510 can be any suitable processing device that can be included in a user computing system 100, server computing system 300, or third party computing system 500. For example, the one or more processors 110, 310, 510 may include one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The one or more processors 110, 310, 510 can be a single processor or a plurality of processors that are operatively connected, for example in parallel.

The one or more memory devices 120, 320, 520 can include one or more non-transitory computer-readable storage mediums, including a Read Only Memory (ROM), Programmable Read Only Memory (PROM), Erasable Programmable Read Only Memory (EPROM), and flash memory, a USB drive, a volatile memory device including a Random Access Memory (RAM), a hard disk, floppy disks, a Blu-ray disk, or optical media such as CD ROM discs and DVDs, and combinations thereof. However, examples of the one or more memory devices 120, 320, 520 are not limited to the above description, and the one or more memory devices 120, 320, 520 may be realized by other various devices and structures as would be understood by those skilled in the art.

The one or more memory devices 120, 320, 520 can store data 122, 322, 522 and instructions 124, 324, 524 which are executed by the one or more processors 110, 310, 510 to cause the user computing system 100, server computing system 300, and third party computing system 500 to perform operations (e.g., operations associated with the methods described herein).

In some example embodiments, the user computing system 100 includes an application system 130. For example, the application system 130 may include an image analysis application. The image analysis application may be implemented via one or more machine-learned models 132 and/or thermal analyzer 134. The application system 130 can include various other applications including document applications, text messaging applications, email applications, media (image, video, etc.) applications, dictation applications, virtual keyboard applications, browser applications, map applications, social media applications, navigation applications, etc.

In some implementations, the user computing system 100 can store or include one or more machine-learned models 132 which may be implemented to execute one or more aspects of applications associated with the application system 130. For example, the one or more machine-learned models 132 can include one or more image classification machine-learned models 1252 (see FIG. 1B), one or more object detection machine-learned models 1254 (see FIG. 1B), etc. For example, the one or more machine-learned models 132 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, transformer neural networks, or other forms of neural networks.

In some implementations, the one or more machine-learned models 132 can be received from the server computing system 300 over network 400, stored in the one or more memory devices 120, and then used or otherwise implemented by the one or more processors 110. In some implementations, the one or more machine-learned models 132 can be received from the third party computing system 500 over network 400, stored in the one or more memory devices 120, and then used or otherwise implemented by the one or more processors 110. In some implementations, the user computing system 100 can implement multiple parallel instances of a single machine-learned model among the one or more machine-learned models 132 (e.g., to perform parallel machine-learned model processing across multiple instances of input data and/or detected features).

More particularly, the one or more machine-learned models 132 may include one or more object detection models, one or more image classification models, one or more image segmentation models, one or more data augmentation models, one or more key-point detection models, one or more generative models, one or more natural language processing models, one or more optical character recognition models, one or more anomaly detection models, and/or one or more other machine-learned models. The one or more machine-learned models 132 can leverage an attention mechanism such as self-attention. For example, the one or more machine-learned models 132 can include multi-headed self-attention models (e.g., transformer models). The one or more machine-learned models 132 may include one or more neural radiance field models, one or more diffusion models, one or more convolutional neural network models, and/or one or more autoregressive language models.

The one or more machine-learned models 132 may be utilized to detect one or more object features. The detected object features may be classified and/or embedded. The classification and/or the embedding may then be utilized to perform a search to determine one or more search results. Additionally, or alternatively, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 132 can process image data, text data, audio data, and/or latent encoding data to generate output data that can include image data, text data, audio data, and/or latent encoding data. The one or more machine-learned models 132 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, anomaly detection, key-point detection, and/or data segmentation (e.g., mask based segmentation).

In some implementations, the thermal analyzer 134 may be configured to implement one or more algorithms to determine or evaluate whether a temperature of an object and/or its subcomponents associated with a structure which is present in an image satisfies a temperature criteria associated with the object. The object can correspond to a shape/region with many pixels associated with it, and each pixel in the thermal image has a temperature value associated with it. The priority/severity level can depend on one or more of these temperature values. For example, the thermal analyzer 134 may be configured to determine whether the temperature of the object and/or its subcomponents exceeds a threshold temperature value associated with the object and/or its subcomponents. In some implementations, the thermal analyzer 134 may be configured to determine a difference between a maximum temperature of a component or connection point and a reference ambient temperature, and can compare the difference with a threshold difference temperature associated with the object and/or its subcomponents and/or can compare the difference with a difference value of one or more other components or connection points associated with the object. In some implementations, various subregions of an object can be analyzed and minimum and maximum temperatures associated with each of the subregions. In some implementations, the thermal analyzer 134 may be configured to implement one or more machine-learned models to determine whether the temperature of the object associated with the structure which is present in the image satisfies the temperature criteria associated with the object. For example, the one or more machine-learned models may be configured to receive as an input a thermal image of the object, ambient temperature information, a class associated with the object, and other information which can be used to determine whether the temperature of the object is abnormal or within threshold limits. For example, the one or more machine-learned models may be trained to identify, for particular components and objects, “positive” thermal profiles which satisfy the temperature criteria and “negative” thermal profiles which do not satisfy the temperature criteria. For example, the one or more machine-learned models may be configured to provide as an output, a determination regarding whether the object satisfies the temperature criteria.

In some implementations, the thermal analyzer 134 may be configured to compute a ranking or priority value for each of a plurality of images which are analyzed. For example, the thermal analyzer 134 may be configured to determine a severity score for each image that can indicate a degree of severity or scale associated with the temperature of the object and/or its subcomponents. For example, an object and/or its subcomponents having a temperature which exceeds a threshold temperature value by more than another object and/or its subcomponents may have a higher severity score and thus be given a higher priority. In some implementations, an image may have multiple detected objects, and the thermal analyzer 134 may be configured to compute a severity determination (score) for each object. The thermal analyzer 134 may be configured to aggregate the severity scores for the objects in the image (using various methods) to determine an overall severity score for the image.

In some example embodiments, the user computing system 100 includes a position determination device 140. Position determination device 140 can determine a current geographic location of the user computing system 100 and communicate the geographic location to the server computing system 300 over network 400. The position determination device 140 can be any device or circuitry for analyzing the position of the user computing system 100. For example, the position determination device 140 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on an IP address, by using triangulation and/or proximity to cellular towers or WiFi hotspots, and/or by using artificial intelligence for searching photo location, and/or other suitable techniques for determining a position of the user computing system 100. For example, in some implementations the image analysis application and the one or more machine-learned models 132 may be configured to utilize position information determined by the position determination device 140 to monitor or track a position of the user computing system 100 associated with the user (e.g., in conjunction with images of the inspection site and/or structure captured by capture device 180). For example, the position information can be used to assist in determining a class associated with the image, in determining an object depicted in the image, etc.

The user computing system 100 may include an input device 150 configured to receive an input from a user and may include, for example, one or more of a keyboard (e.g., a physical keyboard, virtual keyboard, etc.), a mouse, a joystick, a button, a switch, an electronic pen or stylus, a gesture recognition sensor (e.g., to recognize gestures of a user including movements of a body part), an input sound device or speech recognition sensor (e.g., a microphone to receive a voice input such as a voice command or a voice query), a track ball, a remote controller, a portable (e.g., a cellular or smart) phone, a tablet PC, a pedal or footswitch, a virtual-reality device, and so on. The input device 150 may also be embodied by a touch-sensitive display having a touchscreen capability, for example. For example, the input device 150 may be configured to receive an input from a user associated with the input device 150 for executing the image analysis application and implementing the one or more machine-learned models 132, for capturing an image via the capture device 180, for providing feedback to the image analysis application, for communicating with other users, for accepting or declining suggestions or recommendations provided by the user computing system 100 with respect to performing operations associated with the image analysis application, with respect to temperature criteria that are satisfied or not satisfied, with respect to identifying objects in an image, with respect to selecting various options for analyzing the images (e.g., selecting an ambient temperature standard, selecting an image type, etc.).

The user computing system 100 may include a display device 160 which displays information viewable by the user (e.g., via a user interface screen provided via user interface 162). For example, the display device 160 may be a non-touch sensitive display or a touch-sensitive display. The display device 160 may include a liquid crystal display (LCD), a light emitting diode (LED) display, an organic light emitting diode (OLED) display, active matrix organic light emitting diode (AMOLED), flexible display, 3D display, a plasma display panel (PDP), a cathode ray tube (CRT) display, projector, holographic projection device and the like, for example. However, the disclosure is not limited to these example displays and may include other types of displays. The display device 160 can be used by the application system 130 provided at the user computing system 100 to display information to a user relating to the performance of an operation for performing the image analysis (e.g., thermal images, visible light images, graphical user interfaces, instructions relating to performing the visible light and thermal image analysis, etc.), relating to feedback or guidance for performing an operation with respect to the image analysis application, etc. The user interface 162 can be configured to receive inputs and/or provide data for display (e.g., image data, text data, audio data, one or more user interface elements, an augmented-reality experience, a virtual reality experience, and/or other data for display). The user interface 162 may be associated with one or more other computing systems (e.g., the server computing system 300 and/or the third party computing system 500). In some implementations, the user interface 162 can include a viewfinder interface, a search interface, a generative model interface, a social media interface, and/or a media content gallery interface. The display device 160 can be configured to provide, for presentation to a user, one or more user interface screens via the user interface 162 having user interface elements which are selectable by the user. The user interface elements which are selectable by the user can be configured to confirm the completion of an operation, confirm the selection of an option of the image analysis application (e.g., selecting an ambient temperature standard, selecting an image type, identify objects in an image, etc.), confirm the completion of capturing images of the inspection site and/or structure, provide feedback regarding the performance of the one or more machine-learned models 132, etc.

The user computing system 100 may include an output device 170 to provide an output to the user and may include, for example, one or more of an audio device (e.g., one or more speakers), a haptic device to provide haptic feedback to a user (e.g., a vibration device), a light source (e.g., one or more light sources such as LEDs which provide visual feedback to a user), a thermal feedback system, and the like. For example, the output device 170 may provide information relating to performing image analysis operations, relating to the selection of an option of the image analysis application (e.g., selecting an ambient temperature standard, selecting an image type, identifying objects in an image, etc.), relating to capturing images of the inspection site and/or structure, relating to providing feedback regarding the performance of the one or more machine-learned models 132, etc.

The user computing system 100 may include a capture device 180 that is capable of capturing media content (e.g., photos, videos, etc.), according to various examples of the disclosure. For example, the capture device 180 can include an image capturer 182 (e.g., a camera) which is configured to capture images (e.g., photos, videos, etc.). For example, the image capturer 182 can include one or more cameras having an imaging sensor (e.g., a complementary metal-oxide-semiconductor (CMOS) or charge-coupled device (CCD)) with or without filters and/or lenses to capture, detect, or recognize objects, materials, and the like, at an inspection site or structure. For example, the camera can be an infrared camera, a visible light camera, a combination of these, etc. Other image types may include ultraviolet images, x-ray images, multi-spectral images, etc. For example, the capture device 180 can include a sound capturer 184 (e.g., a microphone) which is configured to capture sound or audio (e.g., an audio recording). The media content captured by the capture device 180 may be transmitted to one or more of the server computing system 300 and the third party computing system 500, for example, via network 400. For example, in some implementations, content which is captured by the capture device 180 may be provided as an input to the one or more machine-learned models described herein to determine a class of an image, to detect objects in an image, to determine whether a temperature of a detected object satisfies certain temperature criteria, to rank images based on whether objects within the image satisfy certain temperature criteria, to provide feedback or instructions (guidance) to a user regarding the image analysis operations, etc.

The user computing system 100 may include one or more sensors 190. The one or more sensors 190 may be housed in a housing component that houses the one or more processors 110, the one or more memory devices 120, and/or one or more hardware components, which may store, and/or cause to perform, one or more software packets. For example, the one or more sensors 190 may include an inertial measurement unit which includes one or more accelerometers and/or one or more gyroscopes, one or more magnetometers, one or more proximity sensors, one or more Hall effect sensors, one or more infrared sensors, one or more LIDAR sensors, one or more biological sensors (e.g., a heart rate sensor, a pulse sensor, a retinal sensor, and/or a fingerprint sensor), one or more touch sensors (e.g., a conductive touch sensor and/or a mechanical touch sensor), etc. The one or more accelerometers may be used to capture motion information with respect to the user computing system 100. The one or more gyroscopes may also be used additionally or alternatively to capture motion information with respect to the user computing system 100. The one or more sensors 190 may include sensors that can be used to analyze images of an inspection site and/or structure, to measure a temperature of an inspection site, structure, components, etc. For example, the one or more sensors 190 may include sensors such as sensors to measure a temperature, sensors to measure pressure, sensors to measure electrical characteristics, sensors to measure the presence of gas or leaks, etc.

In some implementations, the image capturer v and/or sensors 190 may be configured to capture image data descriptive of the environment, data descriptive of a structure, data descriptive of a component of the structure, etc. Additionally, and/or alternatively, the image data may be obtained and uploaded from other user devices (e.g., third party computing system 500) that may be specialized for data obtainment or generation.

Referring again to the server computing system 300, in some example embodiments, the server computing system 300 includes an application system 330. For example, the application system 330 may include an image analysis application. The application system 330 can include various other applications including document applications, text messaging applications, email applications, media (image, video, etc.) applications, dictation applications, virtual keyboard applications, browser applications, map applications, social media applications, navigation applications, calendar applications, task scheduler application, etc. In some implementations the server computing system 300 can store or include one or more machine-learned models 332 which may be part of the application system 330. The server computing system 300 can communicate with the user computing system 100 according to a client-server relationship. For example, the one or more machine-learned models 332 can be implemented by the server computing system 300 as a portion of a web service (e.g., a viewfinder service, a visual search service, an image processing service, an ambient computing service, and/or an overlay application service), for example, via an application programming interface (e.g., a model as a service). Thus, the one or more machine-learned models 132 can be stored and implemented at the user computing system 100 and/or the one or more machine-learned models 332 can be stored and implemented at the server computing system 300.

As described above, the server computing system 300 can store or otherwise include the one or more machine-learned models 332 which can be part of application system 330. For example, the one or more machine-learned models 332 can be or can otherwise include various machine-learned models which are the same as the one or more machine-learned models 132. Example machine-learned models include neural networks or other multi-layer non-linear models. Example neural networks include feed forward neural networks, deep neural networks, recurrent neural networks, and convolutional neural networks.

Additionally, and/or alternatively, the server computing system 300 can include and/or be communicatively connected with a search engine 340 that may be utilized to crawl one or more databases (and/or resources). The search engine 340 can process data from the user computing system 100, the server computing system 300, and/or the third party computing system 500 to determine one or more search results associated with the input data. The search engine 340 may perform a term based search, label based search, Boolean based searches, date and/or time based search, image search, embedding based search (e.g., nearest neighbor search), multimodal search, and/or one or more other search techniques.

The server computing system 300 may store and/or provide one or more user interfaces 350 for obtaining input data and/or providing output data to one or more users. The one or more user interfaces 350 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

In some implementations, the user computing system 100 and/or the server computing system 300 can train the one or more machine-learned models 132 and/or 332 via interaction with the third party computing system 500 that is communicatively coupled over the network 400. The third party computing system 500 can be separate from the server computing system 300 or can be a portion of the server computing system 300. Alternatively, and/or additionally, the third party computing system 500 may be associated with one or more web resources, one or more web platforms, one or more other users, and/or one or more contexts. In some implementations, the third party computing system 500 includes or is otherwise implemented by one or more server computing devices.

The machine-learned models described herein may be used in a variety of tasks, applications, and/or use cases. In some implementations, the one or more machine-learned models 132 of the user computing system 100 can additionally be provided at the server computing system 300. In some implementations, operations of the one or more machine-learned models 132 of the user computing system 100 can be performed by the one or more machine-learned models 332 of the server computing system 300, and vice versa. For example, one or more operations of the methods described herein can be performed locally by the one or more machine-learned models 132 when there is no connectivity or there is poor connectivity via the network 400 to the server computing system 300 (e.g., a network condition or network quality such as bandwidth, throughput, etc. is less than a threshold level). For example, one or more operations of the methods described herein can be performed remotely by the one or more machine-learned models 332 when there is sufficient connectivity via the network 400 to the server computing system 300 (e.g., a network condition or network quality such as bandwidth, throughput, etc. is greater than a threshold level), which may allow the user computing system 100 to have access to systems and models with a greater memory and/or processing power. In some implementations, the computing system (e.g., an image analysis application) may be configured to provide an interface (e.g., a user interface) by which a user can provide an input to select whether the one or more machine-learned models 132 of the user computing system 100 or the one or more machine-learned models 332 of the server computing system 300 perform certain tasks or operations, or all of the tasks or operations, associated with the methods described herein.

In some cases, the input to the machine-learned models includes visual data and the task is a computer vision task. In some cases, the input includes pixel data for one or more images and the task is an image processing task. For example, the image processing task can be image classification, where the output is a set of scores, each score corresponding to a different image class and representing the likelihood that the one or more images depict a scene belonging to the image class. The image processing task may be object detection, where the image processing output identifies one or more regions in the one or more images and, for each region, a likelihood that the region depicts an object of interest of a particular object class. As another example, the image processing task can be image segmentation, where the image processing output defines, for each pixel in the one or more images, a respective likelihood for each category in a predetermined set of categories. For example, the set of categories can include a foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input. Other image processing tasks can include image focus tasks in which an image is processed so as to be in focus or not blurred and image diagnostic tasks in which an image is processed to be of sufficient quality so that reliable conclusions can be drawn about the scene and objects therein. As another example, the image processing task may include assessing or analyzing the image for focus quality and/or diagnostic quality and then outputting the results of the assessment or analysis to the user. In some implementations, the user computing system 100 may be configured to receive an input from the user correcting the image based on the result output via the image processing task and/or the user computing system 100 may be configured to receive an input from the user to recapture the image and/or the user computing system 100 may be configured to receive a new image captured via another computing device to replace an image which is of insufficient quality based on the output results. Therefore, a user capturing the image can get immediate feedback and capture a new/better image while still at the location of the equipment that is being inspected.

In some implementations, the input to the machine-learned models of the disclosure can be image data. The machine-learned models can process the image data to generate an output. As an example, the machine-learned models can process the image data to generate an image recognition output (e.g., a recognition of the image data, a latent embedding of the image data, an encoded representation of the image data, a hash of the image data, etc.). As another example, the machine-learned models can process the image data to generate an image segmentation output. As another example, the machine-learned models can process the image data to generate an image classification output. As another example, the machine-learned models can process the image data to generate an image data modification output (e.g., an alteration of the image data, etc.). As another example, the machine-learned models can process the image data to generate an encoded image data output (e.g., an encoded and/or compressed representation of the image data, etc.). As another example, the machine-learned models can process the image data to generate an upscaled image data output, a sharpened image where imperfect focus and/or blurring has been corrected and/or contrast/brightness has been adjusted, etc. As another example, the machine-learned models can process the image data to generate a prediction output.

In some implementations, the input to the machine-learned models of the disclosure can be text, table, or natural language data. The machine-learned models can process the text, table or natural language data to generate an output. As an example, the machine-learned models can process the natural language data to generate a language encoding output. As another example, the machine-learned models can process the text or natural language data to generate a latent text embedding output. As another example, the machine-learned models can process the text or natural language data to generate a translation output. As another example, the machine-learned models can process the text or natural language data to generate a classification output. As another example, the machine-learned models can process the text or natural language data to generate a textual segmentation output. As another example, the machine-learned models can process the text or natural language data to generate a semantic intent output. As another example, the machine-learned models can process the text or natural language data to generate an upscaled text or natural language output (e.g., text or natural language data that is higher quality than the input text or natural language, etc.). As another example, the machine-learned models can process the text or natural language data to generate a prediction output.

In some implementations, the input to the machine-learned models of the disclosure can be latent encoding data (e.g., a latent space representation of an input, etc.). The machine-learned models can process the latent encoding data to generate an output. As an example, the machine-learned models can process the latent encoding data to generate a recognition output. As another example, the machine-learned models can process the latent encoding data to generate a reconstruction output. As another example, the machine-learned models can process the latent encoding data to generate a search output. As another example, the machine-learned models can process the latent encoding data to generate a reclustering output. As another example, the machine-learned models can process the latent encoding data to generate a prediction output.

In some implementations, the input to the machine-learned models of the disclosure can be statistical data. Statistical data can be, represent, or otherwise include data computed and/or calculated from some other data source. The machine-learned models can process the statistical data to generate an output. As an example, the machine-learned models can process the statistical data to generate a recognition output. As another example, the machine-learned models can process the statistical data to generate a prediction output. As another example, the machine-learned models can process the statistical data to generate a classification output. As another example, the machine-learned models can process the statistical data to generate a segmentation output. As another example, the machine-learned models can process the statistical data to generate a visualization output. As another example, the machine-learned models can process the statistical data to generate a diagnostic output.

In some implementations, the input to the machine-learned models of the disclosure can be sensor data. The machine-learned models can process the sensor data to generate an output. As an example, the machine-learned models can process the sensor data to generate a recognition output. As another example, the machine-learned models can process the sensor data to generate a prediction output. As another example, the machine-learned models can process the sensor data to generate a classification output. As another example, the machine-learned models can process the sensor data to generate a segmentation output. As another example, the machine-learned models can process the sensor data to generate a visualization output. As another example, the machine-learned models can process the sensor data to generate a diagnostic output. As another example, the machine-learned models can process the sensor data to generate a detection output.

The user computing system 100 may include a number of applications (e.g., applications 1 through N). Each application may include its own respective machine learning library and machine-learned model(s). For example, each application can include one or more machine-learned models. Example applications include an image analysis application as described herein, a text messaging application, an email application, a dictation application, a virtual keyboard application, a browser application, a social media application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 100 can include a number of applications (e.g., applications 1 through N). Each application may be in communication with a central intelligence layer. Example applications include an image analysis application as described herein, a text messaging application, an email application, a dictation application, a virtual keyboard application, a browser application, a social media application, etc. In some implementations, each application can communicate with the central intelligence layer (and model(s) stored therein) using an API (e.g., a common API across all applications).

The central intelligence layer can include a number of machine-learned models. For example, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the user computing system 100.

The central intelligence layer can communicate with a central device data layer. The central device data layer can be a centralized repository of data for the user computing system 100. The central device data layer may communicate with a number of other components of the user computing system 100, such as, for example, one or more sensors, a context manager, a device state component, and/or additional components. In some implementations, the central device data layer can communicate with each device component using an API (e.g., a private API).

FIG. 1B illustrates a data flow example enacted by one or more computer systems to execute example implementations of one of the disclosed methods for performing image analysis with respect to a structure. Example aspects of the disclosure are directed to a computing system for analyzing images (e.g., visible images and thermal images) that can significantly improve the efficiency and effectiveness of inspections of various systems (e.g., electrical systems, mechanical systems, industrial systems, etc.). For example, the computing system can be implemented to perform thermal inspections on electrical panels. For example, the computing system can be implemented to perform inspections on other types of equipment that are monitored using thermal images (e.g., motors, pumps, gearboxes, HVAC equipment, steam traps, etc.).

FIG. 1B illustrates an example computing system 1200 which includes one or more machine-learned models 1250, image registration module 1260, and thermal analyzer 1280. For example, the computing system 1200 may correspond to user computing system 100 and/or server computing system 300. Referring to FIG. 1B, the computing system 1200 receives a plurality of images 1210 which depict a structure (e.g., electrical, mechanical, or industrial equipment or systems). For example, the plurality of images may have been captured via the image capturer 182 of the user computing system 100. In some implementations, the plurality of images may be transmitted to the computing system 1200 over the network 400 from a user computing device (e.g., a camera, a smartphone, a laptop, etc.). In some implementations, the plurality of images may include thermal images 1220 and visible light images 1230. The example of FIG. 1B shows that the plurality of images may include thermal images 1220 and visible light images 1230, however other kinds of images can also be provided (e.g., multispectral images, x-ray images, etc.). In the context of the disclosure, a thermal image may include images captured along a wavelength from about 700 nm to about 14,000 nm (e.g., infrared images about 700 nm to about 3000 nm and thermal images about 3000 nm to about 14,000 nm). Thermal images from which thermal radiation can be measured to visualize temperature differences and heat patterns can be used by the computing system 1200 to determine whether a temperature of an object satisfies certain temperature criteria.

In some implementations, the one or more machine-learned models 1250 may be configured to receive the visible light images 1230 as an input (e.g., as part of the plurality of images 1210). In some implementations, the one or more machine-learned models 1250 may be configured to also receive the thermal images 1220 as an input (e.g., as part of the plurality of images 1210). In some implementations the one or more machine-learned models 1250 may be configured to additionally receive metadata information 1240 as another input (e.g., obtained from the plurality of images 1210). For example, the metadata information 1240 may include metadata or annotations associated with the captured image that can be automatically included or provided by a user. The metadata or annotations can include time information (e.g., a date and/or time of day), information about the device which captured the image, information about the organization associated with the system being inspected, a classification of the image, information about the image registration (e.g., offset information between visible light image and the thermal image), etc.

In some implementations, the one or more image classification machine-learned models 1252 may be configured to identify particular classes of images with different asset types: e.g., electric panels, motors, steam piping, HVAC equipment, etc. Additionally, the one or more image classification machine-learned models 1252 can classify different subtypes of a category, for example, different styles of electrical panels, such as different styles of solar farm combiner box electrical panels. In some implementations, the output of the one or more image classification machine-learned models 1252 which indicates the particular image class can be used to choose from different object detection models (e.g., from among the one or more object detection machine-learned models 1254) that are specifically trained to deal with the types of objects expected to be found in the type of asset in that image class.

In some implementations, the one or more object detection machine-learned models 1254 may be configured to identify different objects in the image. For example, the one or more object detection machine-learned models 1254 may be configured to identify, for a particular image class, objects including components that are associated with the particular image class. For example, the one or more object detection machine-learned models 1254 may be configured to identify, for an image class corresponding to electric panels, objects including components such as circuit breakers, fuses, contactors, terminals, feed cables, disconnects, etc. In some implementations, the one or more object detection machine-learned models 1254 may be configured to identify each object with the coordinates of a rectangle or polygon that outlines the object in the image. For example, bounding shapes such as bounding boxes, bounding polygons, etc. can be utilized. For example, the objects can be defined in a continuous or non-continuous manner. To determine or identify a particular object, in some implementations the one or more object detection machine-learned models 1254 may include or implement optical character recognition (OCR): OCR technology to extract text from images (e.g., photo notes), producing searchable and editable image metadata. The one or more object detection machine-learned models 1254 can utilize the text information extracted from the images to identify objects in the images. To determine or identify a particular object or areas of interest in an image, in some implementations the one or more object detection machine-learned models 1254 may include or implement one or more segmentation models. For example, each pixel in an image can be classified and assigned a label according to a particular category (e.g., “sky”, “machine”, “cable”, etc.).

In some implementations, the one or more image classification machine-learned models 1252 and one or more object detection machine-learned models 1254 can alternatively, or additionally, be trained to classify and locate objects directly in the thermal images 1220. In some implementations, the one or more image classification machine-learned models 1252 and one or more object detection machine-learned models 1254 are configured to be implemented on a companion visible-light image of the same scene (e.g., structure) captured at the same time (or substantially the same time) and from the same point of view (or substantially the same point of view) as the thermal image. This is especially useful when there is the possibility that objects or components of interest in the scene might be at the same (or close to the same) temperatures, or very close to ambient temperature. When this happens, there may not be enough thermal contrast to see or locate the important objects or components in a thermal image directly. For this to be effective, the image registration module 1260 may be configured to map the visible-image coordinates of the objects to the correct (corresponding) coordinates in the thermal image. The image registration module 1260 may be configured to perform an image registration process by aligning the thermal images 1220 and the visible light images 1230 of the same scene taken from the same perspective or viewpoint and time so that they overlap precisely. The image registration module 1260 may be configured to identify distinct thermal or visible features from the thermal and visible light images (e.g., edges, contours, corners, etc.). The image registration module 1260 may be configured to match features between the thermal and visible light images using known methods (e.g., Scale-Invariant Feature Transform (SIFT), Speeded-Up Robust Features (SURF), etc.). In some implementations, the image registration module 1260 may be configured to transform one or more of the thermal image and the visible light image (e.g., via one or more of a translation, rotation, or scaling operation) to align the thermal image and the visible light image with each other such that pixels from the thermal image match the coordinate system of the visible light image. For example, the computing system 1200 (e.g., image registration module 1260) may be configured to perform an image registration operation by mapping a first set of coordinates associated with the one or more objects in the visible light image to a second set of coordinates associated with the one or more objects in the thermal image. For example, the thermal analyzer 1280 may be configured to determine a temperature associated with each object among one or more objects in the visible light image, by determining a temperature associated with the second set of coordinates associated with the one or more objects in the thermal image.

In some implementations, an image capturer 182 (e.g., a thermal imager) may be configured to automatically capture visible and thermal images at the same time. However, because of parallax, lens distortions and manufacturing tolerances, the visible and thermal images often are not aligned perfectly. If the residual misalignment is not corrected, the object locations from the visible image mapped into the thermal image may not be sufficiently accurate to get desired results. In some implementations, the image capturer 182 (e.g., the thermal imager) may include the image registration module 1260 to map the visible-image coordinates of the objects to the correct (corresponding) coordinates in the thermal image. In some implementations, the computing system 1200 may include the image registration module 1260 (separate from the image capturer 182) which can be implemented in addition to an image registration module provided at the image capturer 182 or can be implemented instead of an image registration module provided at the image capturer 182 or in the case that the image capturer 182 does not include an image registration module. For example, the image registration module 1260 may be configured to implement computer vision techniques to detect the residual misregistration and provide a correction. In some implementations, a visible light image and a counterpart thermal image can be provided as inputs to the image registration module 1260 first where they are registered and then a blended thermal/visible image is output and then fed as an input to the one or more machine-learned models 1250 (e.g., for object detection, object classification, image classification, etc.). In some implementations, the visible light image and the counterpart thermal image can be provided as inputs to the one or more machine-learned models 1250 which can include one or more models configured to perform the image registration process (e.g., instead of image registration module 1260 which can be omitted) according to known methods.

As illustrated in FIG. 1B, the first output 1270 may include information relating to one or more objects which are detected in the visible light image including information relating to the location of the objects in the visible light image, a thermal image which has been aligned with the visible light image via the image registration module 1260, and the metadata information 1240. For example, in some implementations the first output 1270 may be provided for presentation on a display device 160 (e.g., via the user interface 162).

According to examples of the disclosure, the thermal analyzer 1280 may be configured to analyze the temperature information associated with the thermal image, particularly the temperature information associated with the objects that have been detected in the visible light image. For example, the one or more object detection machine-learned models 1254 may be configured to determine one or more regions of interest that correspond to one or more objects in the visible light image. The thermal analyzer 1280 may be configured to analyze the temperature information contained in each region of interest.

For example, the thermal analyzer 1280 may be configured to implement various methods to evaluate whether certain temperature criteria are satisfied. In some implementations, the thermal analyzer 1280 may be configured to analyze the temperature based on the image class as determined by the one or more image classification machine-learned models 1252 and the object class as determined by the one or more object detection machine-learned models 1254. For example, the one or more object detection machine-learned models 1254 may be configured to provide the location and class of the object (e.g., the electric contactor/relay).

In some implementations, the thermal analyzer 1280 may implement a connection point detection and analysis tool. The connection point detection and analysis tool can be implemented for particular objects (e.g., for electrical panels, for wires, for fuses, etc.). For example, the connection point detection and analysis tool can utilize object detection results from the one or more object detection machine-learned models 1254 to detect connection points where wires are connected to an object (e.g., fuse block) and the connection point detection and analysis tool can analyze the temperature of the connection points (which can be a common problem area of the electrical equipment). The thermal analyzer 1280 (connection point detection and analysis tool) can compare temperatures of the connection points to each other and/or to threshold limits to identify problem connections and determine severity or priority rankings.

In some implementations, the thermal analyzer 1280 may implement a wire segmentation model or tool for particular objects (e.g., for electrical panels, for wires, for fuses, etc.). The wire segmentation tool can be configured to identify wires and cables on a pixel-by-pixel basis and the thermal analyzer 1280 may be configured to analyze the temperature along the wire and/or at the endpoints of the wire. In some implementations, the one of the machine learned models 1250 may also be configured to perform the pixel-by-pixel segmentation to identify wires and cables. The temperatures at the wire endpoints may correspond to or coincide with connection points. The thermal analyzer 1280 may be configured to analyze a variation in temperature along a wire to determine particular problems: e.g., wires with a temperature gradient along the wire usually indicate a bad connection at the hot end, while wires with a constant (and high) temperature along the wire can indicate an overloaded circuit.

In some implementations, the thermal analyzer 1280 may be configured to determine whether the temperature of the object (or of a region of interest) exceeds a threshold temperature value associated with the object (or of the region of interest). For example, the thermal analyzer 1280 may be configured to determine a difference between a maximum temperature of a component or connection point and a reference ambient temperature, and can compare the difference with a threshold difference temperature associated with the object and/or can compare the difference with a difference value of one or more other components or connection points associated with the object. For example, the thermal analyzer 1280 may be configured to determine the maximum and minimum temperature in the region of interest associated with the object. In some implementations, the maximum and minimum temperature values can be checked, based on the ambient temperature and other environmental conditions, to verify whether the object/component is within a normal range as defined by various protocols (e.g., standard or default protocols, user-defined protocols, etc.). For example, the thermal analyzer 1280 may be configured to determine (compute) a temperature difference (delta temperature) between a component's maximum temperature and the ambient temperature. The thermal analyzer 1280 can identify different alert levels and/or determine a severity or priority score (ranking) based on the delta value. Alternatively, or in additionally, the thermal analyzer 1280 may be configured to compare the temperatures of an object to additional instances of the same or similar types of object in the image (e.g., temperatures of each of the three fuses in a 3-phase fused disconnect panel can be compared with each other). As another example, the thermal analyzer 1280 may be configured to check the minimum and maximum temperatures of subregions of the component (e.g., temperatures of the ends of an electric contactor/relay (which are expected to be near room temperature) can be compared to temperatures of the middle portion of the electric contactor/relay (which is expected to be quite warm)).

In some implementations, the thermal analyzer 1280 may be configured to implement one or more machine-learned models to determine whether the temperature of the object associated with the structure which is present in the image satisfies the temperature criteria associated with the object. For example, the one or more machine-learned models may be configured to receive as various inputs (e.g., a thermal image of the object, ambient temperature information, a class associated with the object, and other information which can be used to determine whether the temperature of the object satisfies certain temperature criteria (e.g., whether the temperature is abnormal or within threshold limits). In another example, the one or more machine-learned models of the thermal analyzer 1280 may receive inputs such as the image class, an inventory of the objects detected, temperature information (e.g. max, min, stats, etc.) of the objects, the ambient temperature, etc., and then provides an anomaly likelihood or severity output indicating the likelihood that the panel has an electrical anomaly requiring attention. For example, the one or more machine-learned models may be trained to identify, for particular components and objects, “positive” thermal profiles which satisfy the temperature criteria and “negative” thermal profiles which do not satisfy the temperature criteria. In some implementations, image similarity search technology can be utilized by the thermal analyzer 1280 to find the same or visually similar objects in a large collection of images, and thermal analyzer 1280 may be configured to compare temperatures of a particular object in an image with temperatures of the particular object from other images captured at different times and/or to compare temperatures of a particular object in an image with temperatures of similar objects from other images captured at different times. This approach can also be facilitated by storing the image class, object inventory, and various temperatures for each image in a database, and the one or more machine-learned models 1250 or thermal analyzer 1280 can include an anomaly likelihood model which is configured to perform the comparison to other similar images (e.g., based on image class and object inventory) that are found in the database. For example, the one or more machine-learned models may be configured to provide as an output, a determination regarding whether the object satisfies the temperature criteria. In some implementations, the thermal analyzer 1280 can extract multiple temperatures from the object and compare against multiple thresholds (temperature criteria values). For example, the center of the object can be compared against a first threshold (first temperature criteria value) and the periphery of the object can be compared against a different threshold (different temperature criteria values).

For example, the computing system 1200 (e.g., via the thermal analyzer 1280, one or more machine-learned models 1250, and metadata information 1240) can provide (generate) the second output 1290 which can include information (e.g., a notification) indicating whether the object satisfies the temperature criteria, information about the image which captured (e.g., the metadata information 1240), information regarding objects or components that are detected in the image, etc. The second output 1290 may be provided (generated) for presentation via the display device 160 and/or output device 170 (e.g., via user interface 162, via a speaker, etc.). In some implementations, second output 1290 may additionally, or alternatively, include a command or control output which controls a functional system (e.g., a mechanical system, electrical system, an industrial system, etc.). For example, the computing system 1200 may control an electrical system having a component with a temperature outside of acceptable limits (e.g., as determined by the thermal analyzer 1280) to be shut down, or control the component itself to be shut down. For example, the computing system 1200 may cause (generate) a notification (e.g., an alert or warning) to be output (second output 1290) in response to a determination by the thermal analyzer 1280 that a component or object (e.g., an electrical system, a fuse, etc.) has a temperature which does not satisfy the temperature criteria (e.g., is outside of acceptable limits). The alert or warning may include activating a speaker system, lighting system, etc. For example, the computing system 1200 may generate an output a workflow or work order (e.g., as second output 1290) via work management software or programs, for taking corrective action to check, diagnose, fix and/or remedy an electrical system, in response to a determination by the thermal analyzer 1280 that the electrical system has a component with a temperature outside of acceptable limits. For example, the computing system 1200 may be configured to automatically implement a remedial or preventive action (e.g., controlling a component to be shut down, causing a cooling operation to be performed, etc.), in response to a determination by the thermal analyzer 1280 that a component or object (e.g., an electrical system, a fuse, etc.) has a temperature which does not satisfy the temperature criteria (e.g., is outside of acceptable limits).

In some implementations, the computing system 1200 (e.g., thermal analyzer 1280) can be configured to determine a severity or priority score, for each of the components in an image and/or for each image among a plurality of images. The thermal analyzer 1280 can be configured to rank each component in an image with each other, based on the severity or priority scores. The thermal analyzer 1280 can be configured to rank each image among a plurality of images with each other, based on the severity or priority scores. The thermal analyzer 1280 can be configured to rank components from across a plurality of images with each other, based on the severity or priority scores. In some implementations, the thermal analyzer 1280 can be configured to determine an aggregated or combined severity or priority score for an image based on the respective severity or priority scores for each of the components in an image.

Ranking or prioritizing the severity or priority of a system or component is efficient and effective by efficiently prioritizing work or repairs that need to be performed, resulting in reduced downtime, increased uptime, preventing damage to components, etc. According to current practice, a typical workflow often has the user spending several hours or days in the field collecting images for a site and then needing to subsequently analyze them all and manually assign needed service/repair work based on the findings. In contrast, according to examples of the disclosure images can be transmitted or uploaded in batches (e.g., hundreds or thousands of images at a time) and the computing system 1200 can automatically classify the images, detect the objects of interest in each of the images, conduct an appropriate temperature analysis, and rank the images or components or structures needing prioritized attention based on the severity or priority of the conditions as indicated by the severity or priority scores. The thermal analyzer 1280 may be configured to provide for presentation to a user as the second output 1290, the ranking or prioritization of the objects and/or systems, allowing the user to check and review and address issues based on the priority. This can provide an important benefit of getting the most important/urgent work prioritized first which allows repairs and mitigation operations to be implemented earlier, increasing uptime of systems and reducing downtime, as well as preventing or limiting damage to the systems. In some implementations, the computing system 1200 (e.g., via the thermal analyzer 1280) may be configured to automatically address the issues based on the prioritization of the severity or priority scores.

In some implementations, the computing system 1200 (e.g., thermal analyzer 1280) can be configured to implement trend and/or comparison analysis tools to monitor the temperature of objects and components over a period of time. For example, the thermal analyzer 1280 may be implemented via a graphical user interface having one or more user interface elements that are selectable to perform operations. For example, an image of an object may be displayed and the user can select the object through a user interface tool. In response to the selection of the object, the thermal analyzer 1280 may be configured to retrieve historical data relating to the object and/or data relating to similar objects. The historical data may be stored in an image repository or database. The images can be retrieved via OCR technology, image similarity search technology, metadata, etc. The thermal analyzer 1280 may be configured to analyze the temperature information of the object or component obtained over time (e.g., time series data) to identify problems and anomalies. The thermal analyzer 1280 may be configured to compare the temperature data to other similar components or objects (e.g., associated with the same or similar assets or equipment or systems). Automating the object detection and temperature analyses significantly streamlines image analysis operations which allows repairs and mitigation operations to be implemented earlier, increasing uptime of systems and reducing downtime, as well as preventing or limiting damage to the systems.

According to examples of the disclosure, the computing system 1200 may further include a feedback 1295 component which can serve as another input to the one or more machine-learned models 1250. For example, the results from one or more machine-learned models 1250 can be improved by performing an iterative process of training, testing, and retraining the one or more machine-learned models 1250 based on prior results output by the one or more machine-learned models 1250 (e.g., failures or errors, confirmation that the output is correct, etc.). As examples, a user can confirm whether an image and/or object is correctly identified or classified, users can confirm whether bounding shapes are properly placed, etc. For example, user feedback can be logged and the retraining process can be automatic or manual, or a combination thereof. In some implementations, the one or more machine-learned models 1250 can be triggered to be retrained when a user provides feedback, or the human can periodically review a database/log that records all the feedback and then decide if/when retraining is appropriate.

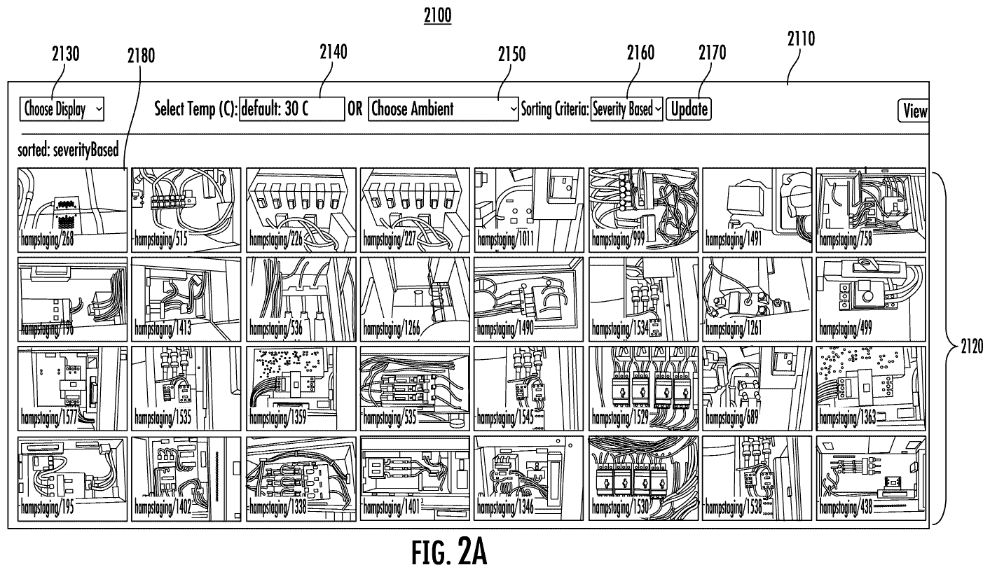

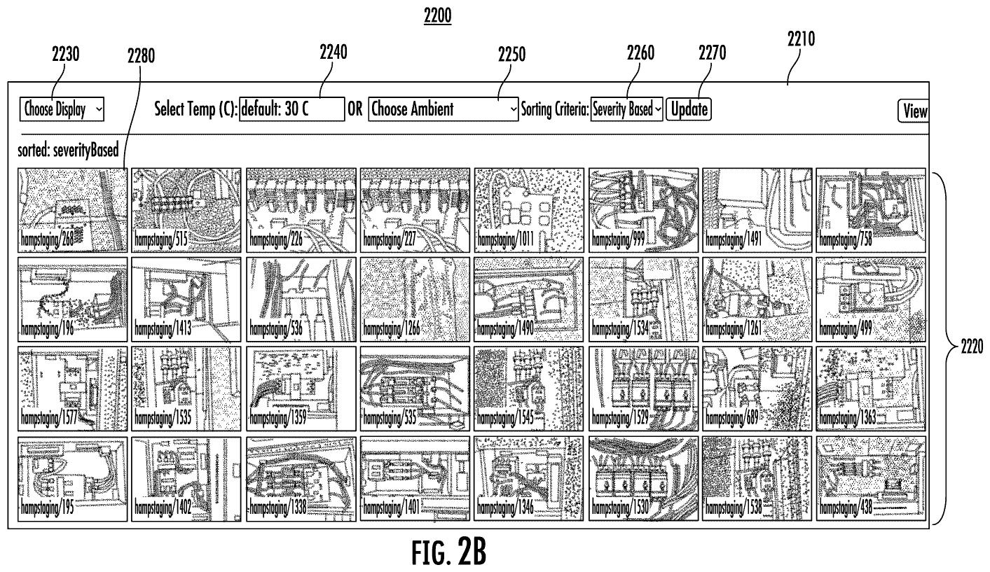

The computing system 1200 can provide, for presentation to a user, various user interfaces (user interface screens) to enable a user to view information relating to one or more objects of a structure depicted in an image. For example, the computing system 1200 can provide, for presentation to a user, various user interface elements that can display the information. For example, the computing system 1200 can provide, for presentation to a user, various user interface elements that are selectable to provide an input. Example user interface screens are described with respect to FIGS. 2A through 6C. In some implementations, the computing system 1200 can provide a user interface that enables the user to move vertices and/or edges of bounding shapes (e.g., bounding boxes) around the objects and/or change/correct the class/identification of objects or images. Further, it can enable the user to adjust the severity level or other parameters (e.g., a method for determining an ambient temperature). In response to receiving an input modifying a particular parameter, the computing system 1200 may be configured to log the modified data and can be configured to retrain or fine tune the one or more machine-learned models 1250 and associated algorithms. The one or more machine-learned models 1250 can in some instances provide a confidence value along with the image/object class, location information, temperature information, etc. The computing system 1200 may be configured to aggregate and/or combine confidence values to provide an overall confidence value for the image (similar to the overall image severity/priority ranking). The computing system 1200 may be configured to prioritize images for review by the user based on the overall confidence value by enabling the user to review the images and correct the images having the lowest confidence values first (e.g. by moving bounding shapes to correctly locate objects, by correcting an identification of an object type, by changing an ambient temperature value, etc.). For example, the computing system 1200 may be configured to, in response to a confidence value of at least one object being less than a threshold confidence value, prompt a user to check and/or adjust at least one parameter associated with at least one of the visible light image or the thermal image (e.g., a bounding shape location, an ambient temperature value, an identification of an object, etc.).

FIGS. 2A through 2B are example user interface screens selecting images for evaluating temperatures of objects associated with a structure, according to example embodiments of the disclosure.

Referring to FIG. 2A, first user interface screen 2100 includes a first portion 2110 having a plurality of user interface elements to perform various operations with respect to images of one or more structures or systems (e.g., electrical systems, mechanical systems, industrial systems, etc.), components, objects, etc. The first user interface screen 2100 also includes a second portion 2120 having the plurality of images of the one or more structures or systems (e.g., electrical systems, mechanical systems, industrial systems, etc.), components, objects, etc. In FIG. 2A, the second portion 2120 includes a plurality of visible light images.

In FIG. 2A, the first user interface screen 2100 includes a first user interface element 2130 which, when selected, can cause a menu to be presented which can allow a user to switch between visible light images and counterpart thermal images. The first user interface screen 2100 includes a second user interface element 2140 which, when selected, can allow a user to manually enter an ambient temperature that can be used to perform image analysis (e.g., by the thermal analyzer 1280). The first user interface screen 2100 includes a third user interface element 2150 which, when selected, can cause a menu to be presented by which a user can select a particular method for the computing system 1200 to determine the ambient temperature in the images (e.g., utilizing a background temperature, utilizing a lowest maximum temperature of a component among a plurality of maximum temperatures of a plurality of components, utilizing a coldest or lowest temperature in the thermal image, utilizing an ambient temperature received from a user via a user, etc.). The first user interface screen 2100 includes a fourth user interface element 2160 which, when selected, can cause a menu to be presented by which a user can select a method for sorting the images (e.g., according to a severity level, according to a date and/or time that the image was captured, according to an image classification, etc.). For example, the second portion 2120 includes a first image 2180 which has the highest severity or priority score. The first user interface screen 2100 includes a fifth user interface element 2170 which, when selected, can cause the first user interface screen 2100 and particularly the second portion 2120 to be updated based on selections of the various user interface elements. In some implementations, the first user interface screen 2100 (e.g., the second portion 2120) can be updated automatically in response to a selection of a particular user interface element.

Referring to FIG. 2B, second user interface screen 2200 includes a first portion 2210 having a plurality of user interface elements to perform various operations with respect to images of one or more structures or systems (e.g., electrical systems, mechanical systems, industrial systems, etc.), components, objects, etc. The second user interface screen 2200 also includes a second portion 2220 having the plurality of images of the one or more structures or systems (e.g., electrical systems, mechanical systems, industrial systems, etc.), components, objects, etc. In FIG. 2B, the second portion 2220 includes a plurality of thermal images. For example, the thermal images may be presented in response to a selection of the first user interface element 2130 switching from the visible light images shown in FIG. 2A to the counterpart thermal images shown in FIG. 2B.

In FIG. 2B, the second user interface screen 2200 includes a first user interface element 2230, a second user interface element 2240, a third user interface element 2250, a fourth user interface element 2260, and a fifth user interface element 2270 which correspond to the first user interface element 2130, second user interface element 2140, third user interface element 2150, fourth user interface element 2160, and fifth user interface element 2170 of FIG. 2A, respectively. Therefore, detailed descriptions of these user interface elements will be omitted for the sake of brevity.

For example, the second portion 2220 includes a plurality of thermal images including a first image 2280 which is provided in a location that indicates the first image 2280 has the highest severity or priority score. Likewise, the remaining thermal images can be ordered in a manner indicating a severity level or priority score. In FIG. 2B, the first image 2280 is a thermal image and counterpart image of the first image 2180 which is a visible light image.

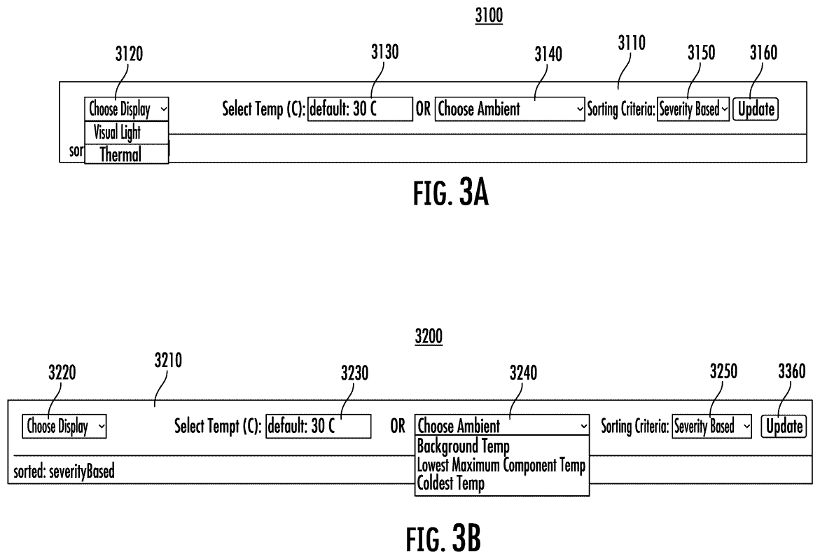

FIGS. 3A through 3B are example user interface screens for evaluating temperatures of objects associated with a structure, according to example embodiments of the disclosure.

Referring to FIG. 3A, first user interface screen 3100 includes a first portion 3110 having a plurality of user interface elements to perform various operations with respect to images of one or more structures or systems (e.g., electrical systems, mechanical systems, industrial systems, etc.), components, objects, etc. The first portion 3110 may correspond to the first portion 2110 and first portion 2210 of FIGS. 2A-2B, for example.

In FIG. 3A, the first user interface screen 3100 further includes a first user interface element 3120, a second user interface element 3130, a third user interface element 3140, a fourth user interface element 3150, and a fifth user interface element 3160 which correspond to the first user interface element 2130, second user interface element 2140, third user interface element 2150, fourth user interface element 2160, and fifth user interface element 2170 of FIG. 2A, respectively. Therefore, detailed descriptions of these user interface elements will be omitted for the sake of brevity. In FIG. 3A, the first user interface screen 3100 includes the first user interface element 3120 which, when selected, can cause a menu to be presented which can allow a user to switch between visible light images and counterpart thermal images (e.g., which may be displayed in thumbnail image form). FIG. 3A illustrates the first user interface element 3120 is implemented via a pulldown menu as one example menu from which a user can switch between visible light images and counterpart thermal images.

Referring to FIG. 3B, second user interface screen 3200 includes a first portion 3210 having a plurality of user interface elements to perform various operations with respect to images of one or more structures or systems (e.g., electrical systems, mechanical systems, industrial systems, etc.), components, objects, etc. The first portion 3210 may correspond to the first portion 2110 and first portion 2210 of FIGS. 2A-2B, for example.

In FIG. 3B, the second user interface screen 3200 includes a first user interface element 3220, a second user interface element 3230, a third user interface element 3240, a fourth user interface element 3250, and a fifth user interface element 3260 which correspond to the first user interface element 2130, second user interface element 2140, third user interface element 2150, fourth user interface element 2160, and fifth user interface element 2170 of FIG. 2A, respectively. Therefore, detailed descriptions of these user interface elements will be omitted for the sake of brevity. FIG. 3B illustrates the third user interface element 3240 is implemented via a pulldown menu as one example menu by which a user can select a particular method for the computing system 1200 to determine the ambient temperature in the images (e.g., utilizing a background temperature, utilizing a lowest maximum component temperature, utilizing a coldest temperature in the image, statistically calculated temperature, etc.). In some implementations, the background temperature value may be recorded when the image was captured and contained in the metadata (e.g., metadata information 1240 in FIG. 1B).

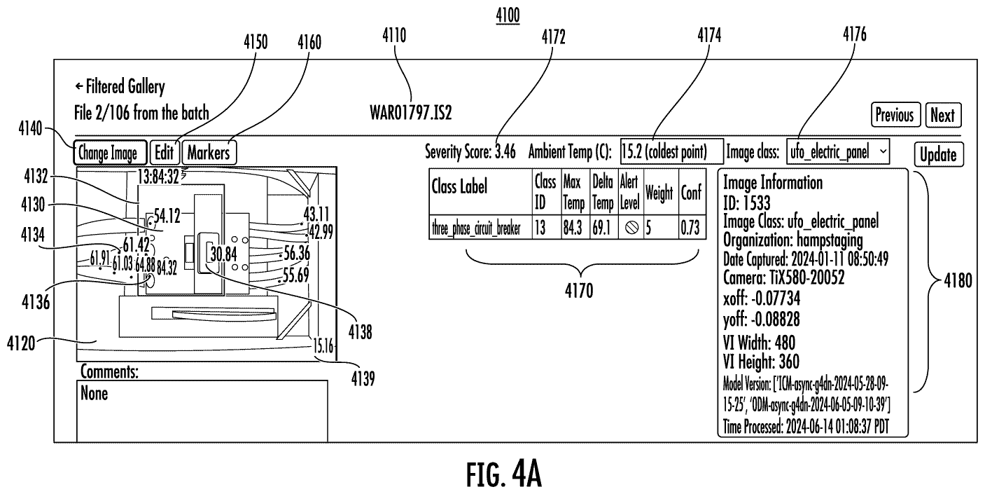

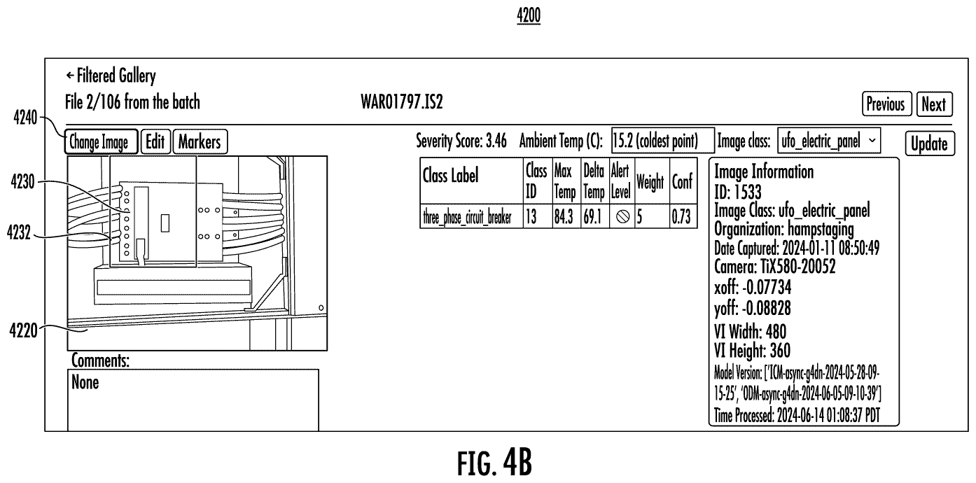

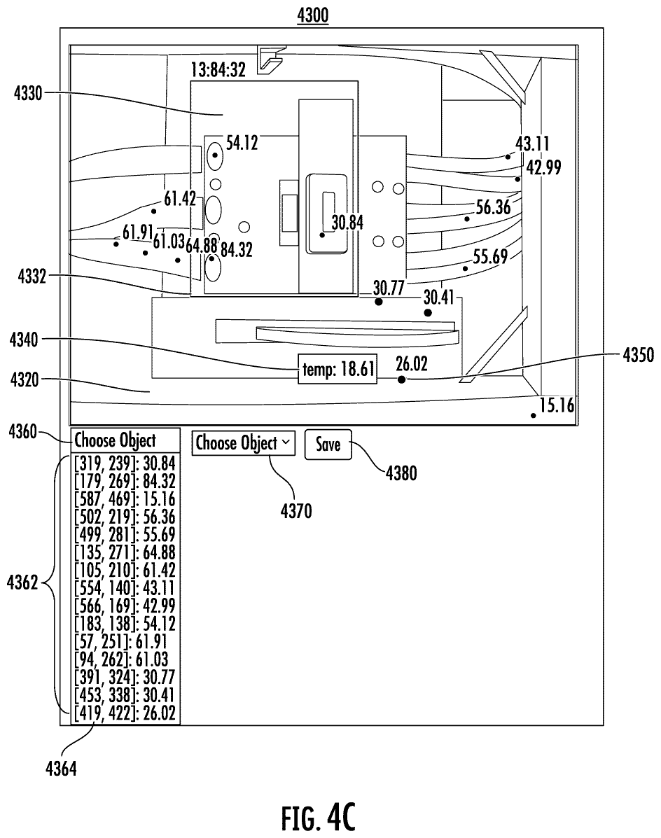

FIGS. 4A through 4C are example user interface screens for analyzing a structure for evaluating temperatures of objects associated with a structure, according to example embodiments of the disclosure.

Referring to FIG. 4A, first user interface screen 4100 includes a plurality of user interface elements which provide information about an image that is selected from a plurality of images, for example, the plurality of images shown in FIG. 2A or FIG. 2B. In particular, a first image 4120 is a thermal image of a component 4130 (object) from an electrical panel. For example, the first image 4120 may be identified by its file name 4110. As indicated in FIG. 4A, the computing system 1200 is configured to indicate the component 4130 with a bounding shape 4132 (e.g., a bounding box). Further, the first image 4120 may include various temperature values for different portions of the image. For example, the first image 4120 may include temperature values for points marked by a user (e.g., via the third user interface element 4160), such as marker point 4134. For example, the first image 4120 may include temperature values for a maximum temperature in the image or a maximum temperature of the component 4130, such as maximum temperature point 4136. For example, the first image 4120 may include temperature values for temperatures in the image or of the component 4130 which are within limits, such as normal temperature point 4138. For example, the first image 4120 may include temperature values for a minimum temperature in the image or a minimum temperature of the component 4130, such as minimum temperature point 4139. The different temperature values may be indicated by corresponding colors (e.g., red for a maximum temperature or a temperature which is outside of acceptable limits, green for an acceptable temperature, blue for a minimum temperature, purple for temperature points marked by a user, etc.).

In FIG. 4A, the first user interface screen 4100 may include a first user interface element 4140 that, when selected, can enable a user to change an image to be examined. For example, the first user interface element 4140, when selected, can enable a user to change the image to be examined to another, different image. For example, the first user interface element 4140, when selected, can enable a user to change the image to be examined to its counterpart image (e.g., switch between thermal and visible light images). In FIG. 4A, the first user interface screen 4100 may include a second user interface element 4150 that, when selected, can enable a user to edit the image under examination (e.g., by modifying a position of the bounding shape 4132). In FIG. 4A, the first user interface screen 4100 may include a third user interface element 4160 that, when selected, can enable a user to add marker points to the image to obtain temperature values of the structure or component corresponding to the marked location in the image.

In FIG. 4A, the first user interface screen 4100 may include a first summary 4170 generated by the computing system 1200 regarding the image or component under examination. For example, the first summary 4170 may include an object class label, an object class identification number, a maximum temperature, a delta temperature (e.g., between the maximum temperature of the component 4130 and the ambient temperature), a severity or alert level, a weight, and a confidence value (e.g., associated with the identification of the object, the measurement of the temperature, etc.). As shown in FIG. 4A, the first user interface screen 4100 may include a fourth user interface element 4172 indicating a severity or priority score (e.g., 3.46 in FIG. 4A) associated with the identified component 4130 in the first image 4120. In some implementations, a severity score may be represented by a user interface element that corresponds to the aggregated severity level for the image. In instances where multiple objects are depicted in an image (e.g., for a structure such as an electrical panel), the severity or alert level may be provided for each object in the image, and fourth user interface element 4172 may be a value corresponding to the combined/aggregated severity of all the objects. For example, object-level alert levels may be shown as a color-coded dot (e.g., red for severe, yellow for warning, etc.), however the alert level can alternatively, or additionally, be indicated as numerical values. As shown in FIG. 4A, the first user interface screen 4100 may include a fifth user interface element 4174 indicating the method used for measuring the ambient temperature and the value of the ambient temperature (e.g., the coldest temperature in the first image 4120). As shown in FIG. 4A, the first user interface screen 4100 may include a sixth user interface element 4176 indicating the image class associated with the component 4130 (e.g., an electrical panel in the example of FIG. 4A).

In FIG. 4A, the first user interface screen 4100 may include a second summary 4180 generated by the computing system 1200 regarding the metadata associated with the image or component under examination. For example, the second summary 4180 may include metadata including the image classification, an organization (e.g., associated with the components or structure which is captured or an organization which captured the image), a date and time associated with capturing the image, an identification of the device which captured the image, offset information regarding the image registration (e.g., in x and y directions), dimension information associated with the image (e.g., resolution information), information associated with the machine-learned models used in generating the image classification, object identification, temperature evaluation, etc., and date and time information associated with processing the image for analyzing the structure and evaluating temperatures of objects associated with the structure. Other information not shown in FIG. 4A may also be included in the second summary 4180.

Referring to FIG. 4B, second user interface screen 4200 includes the plurality of user interface elements as described with respect to FIG. 4A. Different from FIG. 4A, in FIG. 4B the first image 4220 is a visible light image which is the counterpart of first image 4120 shown in FIG. 4A which is a thermal image. For example, the computing system 1200 may be configured to indicate the component 4230 in the first image 4220 with a bounding shape 4232 (e.g., a bounding box). For example, the first image 4220 may be presented by selection of the first user interface element 4240 that, when selected, can enable a user to change the image to be examined to its counterpart image (e.g., switch from the first image 4120 (thermal image) to the first image 4220 (visible light image). In some implementations, the user interface screens for analyzing a structure for evaluating temperatures of objects associated with a structure (e.g., first user interface screen 4100 in FIG. 4A and second user interface screen 4200 in FIG. 4B) can be configured to receive comments from a user (e.g., in the “Comments” section shown in FIGS. 4A and 4B) to enable a user to input comments about their conclusions/assessments of the image. These comments which are associated with the image can be used by the computing system to create reports, work orders, follow up actions, etc. For example, different comment fields can be utilized for different purposes (e.g., problems found, corrective actions required, etc.).

Referring to FIG. 4C, third user interface screen 4300 includes an image under examination indicating various temperature values in the image. In particular, a first image 4320 is a thermal image of a component 4330 (object) from an electrical panel. As indicated in FIG. 4C, the computing system 1200 is configured to indicate the component 4330 with a bounding shape 4332 (e.g., a bounding box). Further, the first image 4320 may include various temperature values for different portions of the image. For example, the first image 4320 may include temperature values for points marked by a user (e.g., via the third user interface element 4160 of FIG. 4A), such as marker point 4350. For example, the computing system 1200 may be configured to provide a temperature value at a particular location in the image which coincides with a hover location over the image, as shown by the first user interface element 4340 which displays the temperature of a particular location in the first image 4320 at a location corresponding to where an input device (e.g., a cursor) is hovering.

According to examples of the disclosure, the computing system 1200 may be configured to select a temperature value to be used as an ambient temperature based on a selection of one of the marker temperature points. As shown in FIG. 4C, the third user interface screen 4300 includes a second user interface element 4360 that, when selected, can enable a user to select a temperature value (e.g., temperature value 4364) from among a plurality of temperature values 4362 that correspond to temperature values in the image (e.g., including marked temperature values, a maximum temperature value, a minimum temperature value, a coldest temperature value, etc.). As shown in FIG. 4C, the third user interface screen 4300 includes a third user interface element 4370 that, when selected, can enable a user to set the selected temperature value (from among the plurality of temperature values 4362) as the ambient temperature (e.g., via a pulldown menu). For example, the third user interface element 4370 may also be configured to, when selected, enable a user to delete the selected temperature value from among the plurality of temperature values 4362. As shown in FIG. 4C, the third user interface screen 4300 includes a fourth user interface element 4380 that, when selected, can enable a user to save the settings selected via the second user interface element 4360 and the third user interface element 4370. The example user interface screens of FIGS. 4A-4C are merely examples, and do not limit the disclosure. Many other arrangements and methods for the user interface elements shown in FIGS. 4A-4C can be implemented (e.g., the plurality of temperature values 4362 could be included in FIG. 4A below the first summary 4170, etc.).

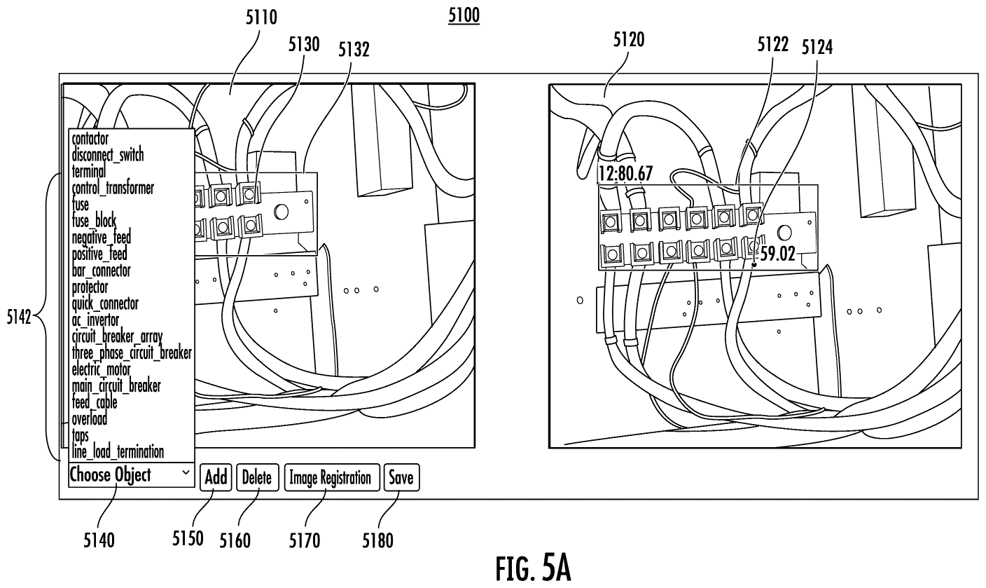

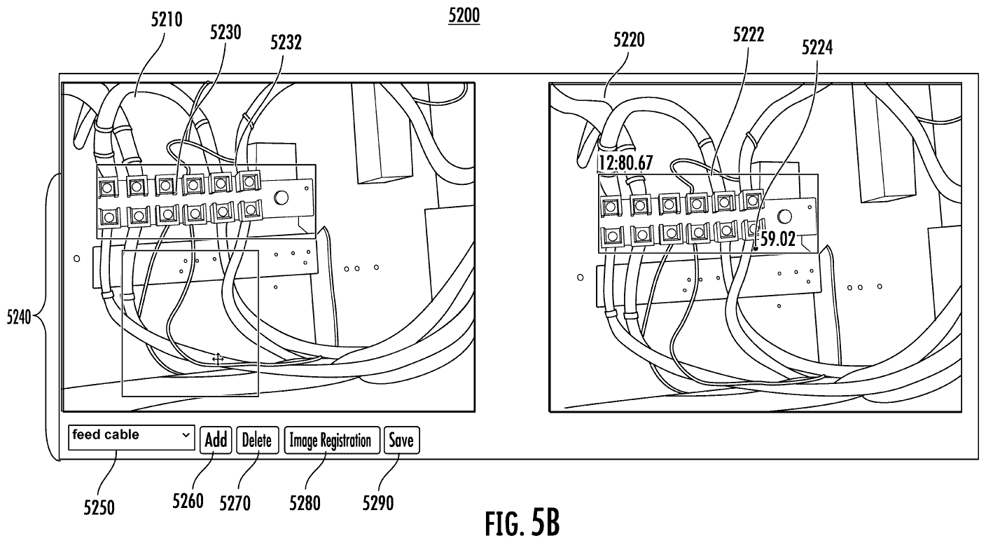

FIGS. 5A through 5B are example user interface screens for identifying objects for evaluating temperatures of objects associated with a structure, according to example embodiments of the disclosure.

Referring to FIG. 5A, first user interface screen 5100 includes a first image 5110 under examination (e.g., a visible light image) including a component 5130 and a second image 5120 (e.g., a thermal image) which is the counterpart image of the first image 5110. The second image 5120 may include a corresponding bounding shape 5122 and temperature information 5124 regarding a particular location of the component 5130. As indicated in FIG. 5A, the computing system 1200 may be configured to indicate the component 5130 with a bounding shape 5132 (e.g., a bounding box). As described herein, the computing system 1200 may be configured to identify the component as a particular component (e.g., as a fuse, a terminal, etc.) within the bounding shape 5132 (a region of interest). In some implementations, the computing system 1200 may be configured to enable a user to edit or correct the identification of the component 5130. In some implementations, the computing system 1200 may be configured to enable a user to change a location of the bounding shape 5132, for example, when the one or more machine-learned models 1250 place the bounding shape 5132 incorrectly. In some implementations, in response to an input changing a location of the bounding shape 5132, the computing system 1200 may be configured to provide, as feedback 1295, the input changing the location of the bounding shape 5132 to the one or more machine-learned models 1250 for updating or improving the performance of the one or more machine-learned models 1250.

For example, the first user interface screen 5100 may include a first user interface element 5140 that, when selected, can enable a user to add a bounding shape to an image to identify an additional object and/or to edit the identification of an already-identified object in the image. For example, the object can be selected from a plurality of objects 5142. For example, a second user interface element 5150 can be configured to, when selected, add the bounding shape to the first image 5110 corresponding to the object selected via the first user interface element 5140. For example, a third user interface element 5160 can be configured to, when selected, delete a bounding shape from the first image 5110 corresponding to a selected bounding shape in the first image 5110 or to an object selected via the first user interface element 5140. For example, a fourth user interface element 5170 can be configured to, when selected, perform another image registration operation based on a current bounding shape selection (e.g., before or after a modification of a location of the bounding shape 5132). As shown in FIG. 5A, the first user interface screen 5100 includes a fifth user interface element 5180 that, when selected, can enable a user to save the settings selected via the first user interface element 5140, second user interface element 5150, third user interface element 5160, and fourth user interface element 5170.

Referring to FIG. 5B, second user interface screen 5200 includes a first image 5210 under examination (e.g., a visible light image) including a component 5230 and a second image 5220 (e.g., a thermal image) which is the counterpart image of the first image 5210. The second image 5220 may include a corresponding bounding shape 5222 and temperature information 5224 regarding a particular location of the component 5230. As indicated in FIG. 5B, the computing system 1200 may be configured to indicate the component 5230 with a bounding shape 5232 (e.g., a bounding box). As described herein, the computing system 1200 may be configured to identify the component as a particular component (e.g., as a fuse, a terminal, etc.) within the bounding shape 5232 (a region of interest).

FIG. 5B shows an additional bounding shape 5240 which has been added to the first image 5210 (e.g., compared to first image 5110 in FIG. 5A). For example, the additional bounding shape 5240 may correspond to feed cable as indicated by a first user interface element 5250. In FIG. 5B, the second user interface screen 5200 includes the first user interface element 5250, a second user interface element 5260, a third user interface element 5270, a fourth user interface element 5280, and a fifth user interface element 5290 which correspond to the first user interface element 5140, second user interface element 5150, third user interface element 5160, fourth user interface element 5170, and fifth user interface element 5180 of FIG. 5A, respectively. Therefore, detailed descriptions of these user interface elements will be omitted for the sake of brevity.

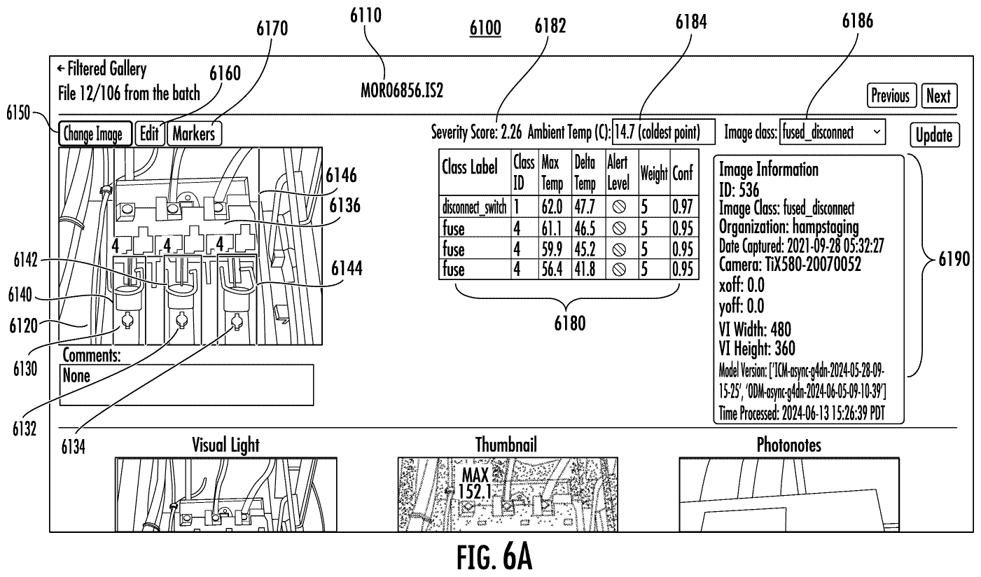

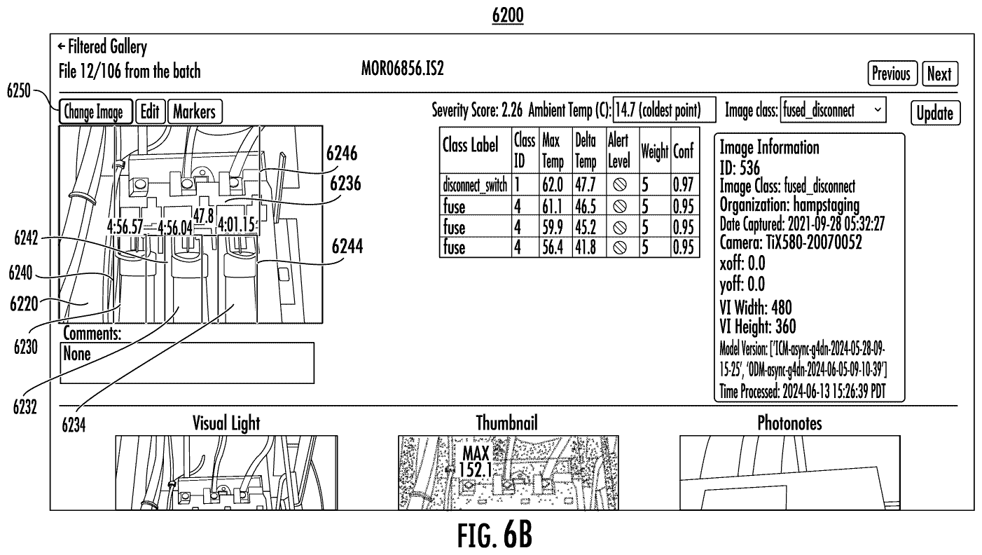

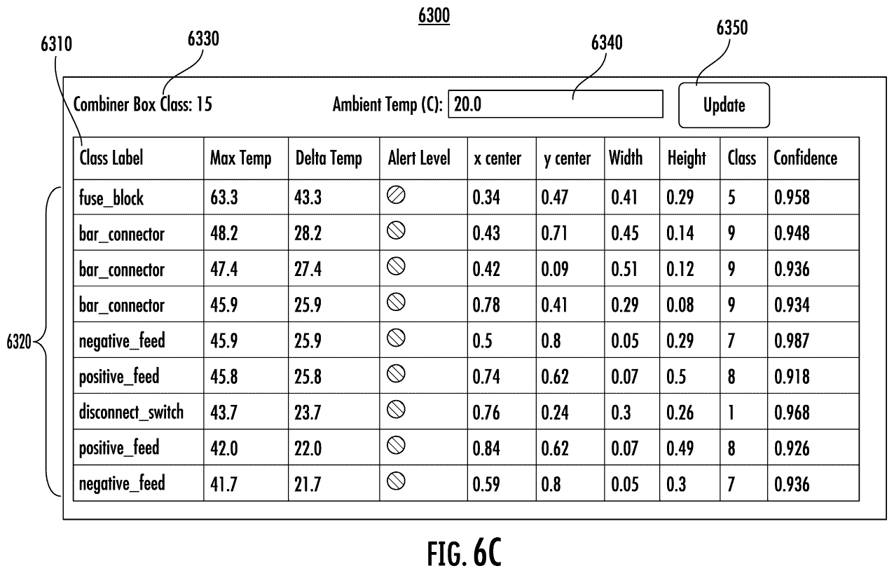

FIGS. 6A through 6C are example user interface screens for identifying a plurality of objects for evaluating temperatures of objects associated with a structure, according to example embodiments of the disclosure.

Referring to FIG. 6A, first user interface screen 6100 includes a plurality of user interface elements which provide information about an image that is selected from a plurality of images, for example, the plurality of images shown in FIG. 2A or FIG. 2B. In particular, a first image 6120 is a visible light image of a plurality of components 6130, 6132, 6134, 6136 (objects such as fuses and a disconnect switch) from a structure (e.g., a three-phase fused disconnect). For example, the first image 6120 may be identified by its file name 6110. As indicated in FIG. 6A, the computing system 1200 may be configured to indicate the plurality of components 6130, 6132, 6134, 6136 with corresponding bounding shapes 6140, 6142, 6144, 6146 (e.g., bounding boxes) associated with regions of interest. Further, the first image 6120 may include various temperature values for different portions of the image.

In FIG. 6A, the first user interface screen 6100 may include a first user interface element 6150, a second user interface element 6160, and a third user interface element 6170 which correspond to the first user interface element 4140, second user interface element 4150, and third user interface element 4160, respectively, from FIG. 4A. Therefore, detailed descriptions of these user interface elements will be omitted for the sake of brevity. Similar to FIG. 4A, the first user interface screen 6100 may also include a first summary 6180 generated by the computing system 1200 regarding the components under examination. For example, the first summary 6180 may include, for each of the plurality of components 6130, 6132, 6134, 6136 a class label, a class identification number, a maximum temperature, a delta temperature (e.g., between the maximum temperature of the respective component and the ambient temperature), a severity or alert level, a weight, and a confidence value (e.g., associated with the identification of the object, the measurement of the temperature, etc.). As shown in FIG. 6A, the first user interface screen 6100 may include a fourth user interface element 6182, a fifth user interface element 6184, and a sixth user interface element 6186, which correspond to the fourth user interface element 4172, fifth user interface element 4174, and sixth user interface element 4176, respectively, from FIG. 4A. Therefore, detailed descriptions of these user interface elements will be omitted for the sake of brevity.

In FIG. 6A, the first user interface screen 6100 may include a second summary 6190 generated by the computing system 1200 regarding the metadata associated with the image or components under examination. For example, the second summary 6190 may include metadata including the image classification, an organization (e.g., associated with the components or structure which is captured or an organization which captured the image), a date and time associated with capturing the image, an identification of the device which captured the image, offset information regarding the image registration (e.g., in x and y directions), dimension information associated with the image (e.g., resolution information), information associated with the machine-learned models used in generating the image classification, object identification, temperature evaluation, etc., and date and time information associated with processing the image for analyzing the structure and evaluating temperatures of objects associated with the structure. Other information not shown in FIG. 6A may also be included in the second summary 6190.

Referring to FIG. 6B, second user interface screen 6200 includes the plurality of user interface elements as described with respect to FIG. 6A. Different from FIG. 6A, in FIG. 6B the first image 6220 is a thermal image which is the counterpart of first image 6120 shown in FIG. 6A which is a visible light image. For example, the computing system 1200 may be configured to indicate the plurality of components 6230, 6232, 6234, 6236 in the first image 6220 with corresponding bounding shapes 6240, 6242, 6244, 6246 (e.g., bounding boxes). For example, the first image 6220 may be presented by selection of the first user interface element 6250 that, when selected, can enable a user to change the image to be examined to its counterpart image (e.g., switch from the first image 6120 (visible light image) to the first image 6220 (thermal image).

Referring to FIG. 6C, third user interface screen 6300 includes another example summary section for a plurality of objects which are identified (detected) in an image. For example, the third user interface screen 6300 includes a table 6310 which summarizes features of each of a plurality of objects 6320 which are part of a structure (e.g., a combiner box) as indicated by a first user interface element 6330 that indicates the image classification. The third user interface screen 6300 further includes a second user interface element 6340 to input an ambient temperature that can be used to determine whether one or more of the plurality of objects 6320 has a temperature within an acceptable limit. The third user interface screen 6300 further includes a third user interface element 6350 that, when selected, can update the values in the table 6310 (e.g., the delta temperature values, alert or severity levels, etc.).

The third user interface screen 6300 may also include the table 6310 generated by the computing system 1200 regarding the components under examination. For example, the table 6310 may include, for each of the plurality of objects 6320, a class label, a class identification number, a maximum temperature, a delta temperature (e.g., between the maximum temperature of the respective component and the ambient temperature), a severity or alert level, offset information regarding the location of the object in the image (e.g., x_center and y_center, dimension information (e.g., width and height information in particular units such as number of pixels, centimeters, etc.), a weight, and a confidence value (e.g., associated with the identification of the object, the measurement of the temperature, etc.). In the example of FIG. 6C, x center, y center, width, and height, are given as a fractional value between [0, 1]. The computing system 1200 may be configured to convert these values to pixel location/dimension by multiplying by the number of pixels in the x or y direction, as appropriate. For example, for an x center value of 0.3 with a pixel image of dimension 320×240 pixel image, the pixel corresponds to the 96th pixel in the x-direction (0.3*320=96).

Referring to the table 6310, the ‘Max Temp’ may correspond to the maximum temperature value for that particular ‘Class Label’ (component). The ‘Delta Temp’ may correspond to the difference between ‘Max Temp’ and ‘Ambient Temp’ value set in the second user interface element 6340. As described herein, different methods can be used to determine the ambient temperature. For example, the ambient temperature may be set according to a user input (e.g., users can provide an input via the second user interface element 6340 (e.g., via a text box entry) and enter the ambient temperature value for that asset or object. In some implementations, a user can select an option (e.g., via a user interface element) to set the lowest component maximum temperature as the ambient temperature method. In the example table 6310 of FIG. 6C, the computing system 1200 may be configured to determine an ambient temperature of 41.7° C. which is the lowest maximum temperature among the maximum temperatures of each of the plurality of objects 6320. In some implementations, a user can select an option (e.g., via a user interface element) to set lowest temperature for the entire structure or in the image as the ambient temperature. In some implementations, a user can hover over an image (e.g., with an input device and cursor location) and mark a location (e.g., a pixel) in the image, where the temperature at that marked location (pixel) can be used as the ambient temperature. In some implementations, a default value can be used as the ambient temperature. In some implementations, a statistically calculated value can be used as the ambient temperature (e.g., the 10th percentile pixel temperature, the median temperature, the average temperature minus 2 standard deviations, etc.).

The computing system 1200 may be configured to determine an ‘Alert Level’ for a particular component or object based on the ‘Delta Temp’ value. As shown in Table 1, example alert levels can include a “watch” level, a “moderate” level, a “severe” level, etc. In some implementations, the computing system 1200 may be configured to determine an overall severity or priority score for the structure (asset) comprising the plurality of components/objects, based on the alert levels and delta temperatures for all the components/objects. In some implementations, the alert level for an object can also depend on the absolute maximum temperature of the object, a combination of the overall maximum and the Delta Temp value, a statistical value computed from the pixel temperatures enclosed by the object's bounding box/shape, etc.

TABLE 1

| Delta Temp (t) | Alert Level | Weight (w) |
|---|---|---|
| t < 10 | — | 0 |
| 10 <= t < 20 | Watch (yellow) | 1 |
| 20 <= t < 40 | Moderate (orange) | 3 |
| 40 <= t | Severe (red) | 5 |

In some implementations, the computing system 1200 may be configured to determine a combined severity score according to a delta temperature value, a weight value associated with a particular alert level associated with the delta temperature value, and the total number of components under analysis or examination (e.g., in the visible light image or thermal image). An example formula for determining the combined severity score can be computed as follows: combined severity score=(Σtᵢ×wᵢ/n*100). In the example formula, n is the total components associated with the structure, and i goes from 1 to n. According to the example formula with respect to FIG. 6C, the computing system 1200 would determine the combined severity score as: Combined severity score=(43.3*5+28.2*3+27.4*3+ . . . +21.7*3)/(9*100)=0.909. However, the example formula is merely an example, and the disclosure is not limited to this formula as there are many other possible equations or algorithms that can be implemented for combining the individual object alert levels into an overall image-level alert level (e.g., including non-linear equations).

The computing system 1200 may be configured to determine a combined severity score for each of a plurality of images and rank the images according to their respective combined severity scores. The computing system 1200 can be configured to provide, for presentation to the user, a user interface which displays the ranked images according to the combined severity rankings, thus enabling a user to quickly identify the most severe structures (assets) that require attention first. In some implementations, the computing system 1200 can be configured to determine a severity score for each object among a plurality of objects in an image or for each object among objects across a plurality of images. For example, the computing system 1200 can rank the objects for a particular image, or can rank the objects for all of the objects from across a plurality of images. For example, the computing system 1200 may be configured to provide, for presentation to the user, a user interface which displays the ranked objects according to the severity rankings associated with the objects, thus enabling a user to quickly identify the most severe objects (components) that require attention first. There are many alternative approaches that can be imagined for determining alerts and severity. In some implementations, the computing system 1200 may be configured to, via a user interface, edit or set values associated with delta temperature thresholds and weights for different alerts.

Aspects of the disclosure include the use of AI and machine-learned models for object detection and image classification in images, the integration of multiple tools for comprehensive thermal analysis, and the use of OCR and image similarity search for trend and comparison analysis. These features improve upon existing solutions by providing more accurate and detailed thermal analysis, enabling early detection of potential issues, and facilitating efficient inspection of assets. Examples of the disclosure are directed to computer implemented methods for analyzing images of electrical, mechanical, and industrial systems, etc., via one or more machine-learned models.

FIG. 7 is an example computer-implemented method 7100 for analyzing images of electrical, mechanical, and industrial systems, etc., by implementing one or more machine-learned models, according to example embodiments of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 7, at operation 7110 the method 7100 includes a computing device obtaining a visible light image which depicts a structure and a thermal image which depicts the structure. As described herein, the computing device may be embodied as user computing system 100, server computing system 300, or combinations thereof. For example, the computing device can receive a plurality of images (including visible light images and thermal images) which depict a structure (e.g., electrical, mechanical, or industrial equipment or systems). For example, the plurality of images may have been captured via the same image capturer 182 of the user computing system 100 or different image capturer devices. In some implementations, the plurality of images may be transmitted to the computing device over a network (e.g., network 400) from another computing device (e.g., a camera, a smartphone, a laptop, etc.). For example, the visible light image and the thermal image may be captured at substantially the same time (e.g., within less than one second) and from substantially a same perspective view (e.g., within ±10 degrees, within ±5 degrees, etc.).

At operation 7120 the method 7100 includes the computing device implementing one or more first machine-learned models to identify a class associated with the structure in the visible light image, based on the visible light image. For example, the one or more first machine-learned models can include the one or more machine-learned models 1250 (e.g., the one or more image classification machine-learned models 1252). For example, the one or more image classification machine-learned models 1252 may be configured to identify particular classes of images with different asset types: e.g., electric panels, motors, steam piping, HVAC equipment, etc. Additionally, the one or more image classification machine-learned models 1252 can classify different subtypes of a category, for example, different styles of electrical panels, such as different styles of solar farm combiner box electrical panels. For example, the one or more image classification machine-learned models 1252 may be configured to identify one or more classes of images associated with the structure in the visible light image, based on the visible light image and the thermal image.

At operation 7130 the method 7100 includes the computing device implementing one or more second machine-learned models to identify one or more objects associated with the structure in the visible light image, based on the visible light image and the class associated with the structure. For example, the one or more second machine-learned models can include the one or more machine-learned models 1250 (e.g., the one or more object detection machine-learned models 1254). For example, the one or more object detection machine-learned models 1254 may be configured to identify, for a particular image class, objects including components that are associated with the particular image class. For example, the one or more object detection machine-learned models 1254 may be configured to identify, for an image class corresponding to electric panels, objects including components including circuit breakers, fuses, contactors, terminals, feed cables, disconnects, etc. For example, the one or more object detection machine-learned models 1254 may be configured to identify one or more objects in the visible light image, based on the visible light image, the thermal image, and the class associated with the structure. In some implementations, operation 7120 can be omitted and the one or more second machine-learned models (e.g., the one or more object detection machine-learned models 1254) may be configured to identify the one or more objects associated with the structure in the visible light image based on the visible light image (e.g., without an output or indication of the image class from the one or more first machine-learned models). For example, the application system 130 may include an application which is dedicated to or specific to a particular solution or a particular class of structure (e.g., an application for electric panels, an application for steam traps, etc.) such that the class of structure may be known or assumed or inferred by the one or more second machine-learned models (e.g., the one or more object detection machine-learned models 1254). In another implementation, the user may provide an input indicating the image class (e.g., from a pulldown menu) and the one or more second machine-learned models (e.g., the one or more object detection machine-learned models 1254) may be configured to identify the one or more objects associated with the structure in the visible light image based on the visible light image and the indication of the image class from the user input. As another implementation, the one or more second machine-learned models (e.g., the one or more object detection machine-learned models 1254) may be trained for a multitude (e.g., hundreds or thousands) of components that cross applications such that a particular object detection model need not be selected (based on an image class) for identifying objects in the image.

At operation 7140 the method 7100 includes the computing device determining a temperature associated with each object among the one or more objects, based on the thermal image. For example, the thermal analyzer 1280 may be configured to analyze the temperature information associated with the thermal image, particularly the temperature information associated with the objects that have been detected in the visible light image. In some implementations, the computing device may be configured to select the object detection machine-learned model from among a plurality of object detection machine-learned models based on the class identified by the image classification machine-learned model.

In some implementations, the one or more second machine-learned models (e.g., the one or more object detection machine-learned models 1254) may be configured to identify the one or more objects associated with the structure in the visible light image, based on the visible light image and the class associated with the structure, by providing a bounding shape (e.g., a bounding box) to indicate a location of the respective object in at least one of the visible light image or the thermal image. In some implementations, the computing device may be configured to receive an input changing a position of the bounding shape to indicate a changed location of the respective object in the at least one of the visible light image or the thermal image, and the one or more second machine-learned models can be updated based on the input (e.g., via feedback 1295).

In some implementations, the one or more second machine-learned models (e.g., the one or more object detection machine-learned models 1254) may be configured to identify a plurality of objects in the visible light image (e.g., a first object, a second object, and a third object connecting the first object and the second object). For example, the third object (e.g., a connection point) may be associated with a first temperature criteria which is different from a second temperature criteria associated with the first object and the second object (e.g., fuses).

At operation 7150 the method 7100 includes the computing device evaluating, for each object among the one or more objects, whether a temperature associated with a respective object among the one or more objects satisfies a temperature criteria associated with the respective object. For example, the thermal analyzer 1280 may be configured to implement various methods to evaluate whether certain temperature criteria are satisfied. In some implementations, the thermal analyzer 1280 may be configured to analyze the temperature based on the image class as determined by the one or more image classification machine-learned models 1252 and the object class as determined by the one or more object detection machine-learned models 1254. For example, the temperature criteria may correspond to a threshold temperature value (e.g., a maximum temperature, a range of temperatures, a delta temperature value, etc.). For example, the thermal analyzer 1280 may be configured to determine a difference between a maximum temperature of a component or connection point and a reference ambient temperature, and can compare the difference with a threshold temperature difference value associated with the object and/or can compare the difference with a difference value of one or more other components or connection points associated with the object. For example, the thermal analyzer 1280 may be configured to determine, as a temperature value, a difference between a temperature of a first object among a plurality of objects in the visible light image and/or thermal image, and a second object among the plurality of objects. The temperature criteria may correspond to a threshold temperature difference value associated with a difference in temperatures among the plurality of objects. The thermal analyzer 1280 may be configured to compare the difference between the first object and the second object to one or more threshold temperature differences to determine an alert level. For example, if the temperature difference is greater than a first threshold temperature difference, a first alert level may be determined (e.g., a moderate alert level), and if the temperature difference is greater than a second threshold temperature difference (greater than the first threshold temperature difference), a second alert level may be determined (e.g., a severe alert level).

At operation 7160 the method 7100 includes the computing device providing an output based on the evaluating. For example, the computing device can provide, for presentation to a user, the output based on the evaluating. The output can include an audio output, a display output, or combinations thereof. The output can include the second output 1290, for example.

In some implementations, the output can include a ranking of objects based on various factors. For example, the computing device may be configured to determine a priority level of each of the one or more objects based on the temperature value of each respective object among the one or more objects, a respective weight value associated with the temperature value, and a number of objects identified in the visible light image via the one or more second machine-learned models. The computing device may further provide the output based on the priority level of each of the one or more objects, for example, by outputting an object having the highest priority level (e.g., a highest severity score or level) first or presenting the object in a particular location so that a user can easily discern objects needing urgent attention first.

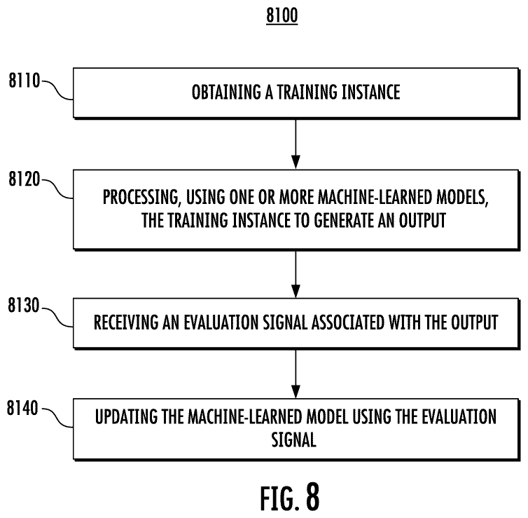

Referring now to FIG. 8, depicted is a flowchart diagram of an example method 8100 for training one or more machine-learned models. The method 8100 can facilitate the iterative process of refining a machine-learned model to improve its performance in generating predictions based on input data. The method 8100 can be implemented by a computing system that includes one or more computing devices, which can execute the steps of the method 8100 using one or more machine-learned models stored in memory.

At 8110, the method 8100 can include obtaining a training example. This training example can be a piece of data or a set of data used to train the machine-learned model. Training examples can be sourced from various datasets, such as a training dataset, a validation dataset, or a testing dataset, and can be labeled or unlabeled, synthesized or unsynthesized, depending on the learning paradigm employed (e.g., supervised, unsupervised, semi-supervised, or reinforcement learning).

At 8120, the method 8100 can include processing the training example to generate a prediction. This step can involve using one or more machine-learned models to analyze the training example and produce an output. The output can be a direct prediction from the machine-learned model or can result from a sequence of processing operations that include the model's output. The processing can leverage various machine learning techniques, such as neural networks, decision trees, or support vector machines, to interpret the training example and derive a prediction.

At 8130, the method 8100 can include receiving an evaluation signal (e.g., loss signal) associated with the prediction. The loss signal can be computed using a loss function that measures the discrepancy between the predicted output and the ground truth or expected output. Different types of loss functions can be utilized, such as mean squared error for regression tasks or cross-entropy loss for classification tasks. The loss signal provides feedback on the accuracy of the prediction, which can be used to adjust the parameters of the machine-learned model.

At 8140, the method 8100 can include updating the machine-learned model using the loss signal. This operation can involve adjusting the values of the model's parameters to minimize the loss signal, thereby improving the model's predictive capability. Techniques such as gradient descent or backpropagation can be employed to iteratively update the parameters based on the gradient of the loss signal with respect to the parameter values. This updating process can be performed over multiple training iterations, with the objective of converging to a set of parameter values that yield the best performance of the model on the training data.

The method 8100 can be part of a larger training procedure that includes pre-training, fine-tuning, and potentially refining the model with user feedback. Pre-training can involve training the model on a large-scale dataset to establish a broad performance base, while fine-tuning can focus on smaller-scale training on higher-quality data. User feedback can further refine the model's performance by incorporating real-world usage data and human evaluations.

In some implementations, the method 8100 can be adapted to various stages of model training, allowing for flexibility in the training process. For instance, certain portions of the machine-learned model can be “frozen” during fine-tuning to retain information learned from broader domains, or the method 8100 can be implemented for specific tasks such as online training or reinforcement learning based on runtime inferences.

Overall, the method 8100 provides a structured approach to training machine-learned models, enabling the iterative improvement of model performance through the acquisition of training examples, processing to generate predictions, receiving loss signals, and updating the model parameters. This structured training process can enhance the ability of machine-learned models to accurately predict outcomes and generalize to new, unseen data.

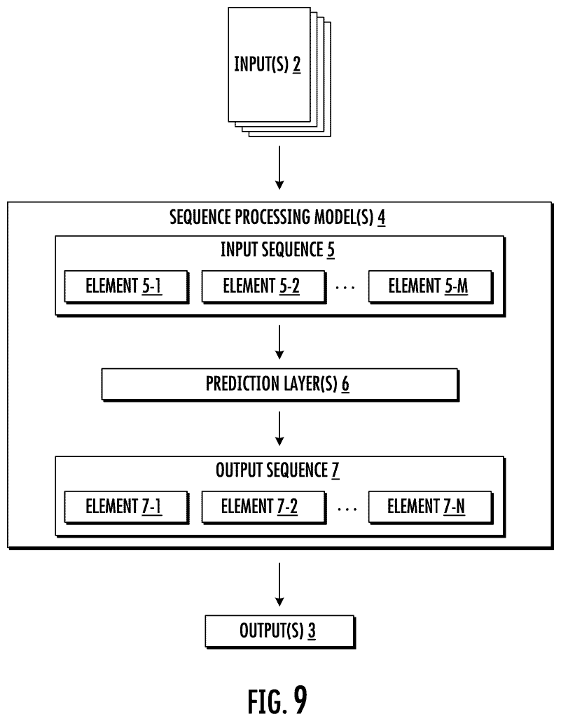

Referring now to FIG. 9, a block diagram illustrates an example implementation of a sequence processing model(s) 4 configured to process sequences of information. The sequence processing model(s) 4 can receive input(s) 2, which may include a variety of data types such as text, images, audio, or other forms of data. These input(s) 2 are then processed to obtain an input sequence 5, which is a representation of the data in a format understood by the sequence processing model(s) 4.

Sequence processing model(s) 4 can include one or multiple machine-learned model components configured to ingest, generate, or otherwise reason over sequences of information. For example, some example sequence processing models in the text domain are referred to as “Large Language Models,” or LLMs. Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, biochemical domains, by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

The input sequence 5 comprises a series of input elements, denoted as element 5-1, element 5-2, . . . , through element 5-M, where M represents the total number of elements in the input sequence 5. Each element within input sequence 5 can represent discrete or continuously distributed data points within an embedding space, capturing the essential information conveyed by input(s) 2.

The sequence processing model(s) 4 further include prediction layer(s) 6, which can process the input sequence 5 to generate an output sequence 7. The prediction layer(s) 6 are composed of one or more machine-learned model architectures that manipulate and transform the input elements to extract higher-order meaning and relationships between them. This transformation allows for the prediction of new output elements based on the context provided by the input sequence 5.

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Output sequence 7 is generated from prediction layer(s) 6 and includes a series of output elements, labeled as element 7-1, element 7-2, . . . , through element 7-N, where N represents the total number of elements in the output sequence 7. These output elements can be the result of autoregressive generation, where each likely next output element is sampled and added to the context window for subsequent predictions. Alternatively, output sequence 7 can be generated non-autoregressively, predicting multiple output elements together without sequential conditioning.

The system can then generate output(s) 3 based on the output sequence 7. These output(s) 3 can be utilized in various applications, such as content generation, classification, or instruction implementation, depending on the nature of the input(s) 2 and the configuration of the sequence processing model(s) 4.

In some implementations, sequence processing model(s) 4 can be adapted for specific tasks or data domains. For instance, sequence processing model(s) 4 can be configured to process textual input for natural language understanding tasks or image-based input for visual recognition tasks. The flexibility of sequence processing model(s) 4 allows them to handle multimodal input sequences, facilitating information extraction and reasoning across diverse data modalities.

Alternative implementations may include sequence processing model(s) 4 with different configurations of prediction layer(s) 6, such as transformer-based architectures, recurrent neural networks (RNNs), long short-term memory (LSTM) models, or convolutional neural networks (CNNs), Generative adversarial networks (GANs). These various architectures can enable sequence processing model(s) 4 to understand or generate sequences of information that are tailored to the specific requirements of the application at hand.

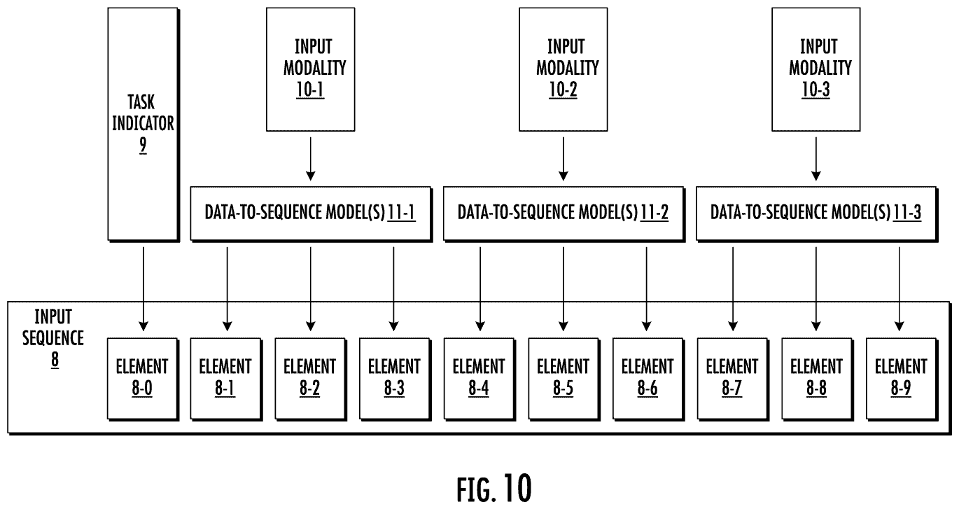

Referring now to FIG. 10, a block diagram illustrates an example implementation of a multi-modal sequence processing model that can populate an input sequence 8. Central to this implementation is the task indicator 9, which can provide a signal to the model(s) processing the input sequence 8, indicating the specific task being performed. This task indicator 9 can include a model or component configured to identify a particular task and inject a corresponding input value into the input sequence 8, represented by element 8-0. The input value can be a learned representation within a continuous embedding space, signaling to the model(s) the nature of the task at hand.

The system further includes various input modalities, such as input modality 10-1, input modality 10-2, and input modality 10-3, each associated with different data types. For instance, input modality 10-1 might represent textual data, input modality 10-2 might represent image data, and input modality 10-3 might represent audio data. Each input modality can provide a unique set of data that contributes to the multimodal nature of the input sequence 8.

Data-to-sequence models, specifically data-to-sequence model(s) 11-1, data-to-sequence model(s) 11-2, and data-to-sequence model(s) 11-3, are adapted to project data from their respective input modalities into a format compatible with the input sequence 8. These models can transform the data to obtain elements 8-1, 8-2, 8-3, etc., for input modality 10-1; elements 8-4, 8-5, 8-6, etc., for input modality 10-2; and elements 8-7, 8-8, 8-9, etc., for input modality 10-3. The elements within input sequence 8 can indicate specific locations within a multidimensional embedding space, mapping to discrete or continuously distributed locations depending on the nature of the data.

In some implementations, the data-to-sequence models 11-1, 11-2, and 11-3 can be trained jointly or independently from the machine-learned sequence processing model(s) 4 to facilitate end-to-end training. These models can form part of the machine-learned sequence processing model(s) 4 illustrated in FIG. 9, enhancing the system's ability to extract and reason over information from diverse data modalities.

The input sequence 8, as depicted in FIG. 10, represents a multimodal input sequence that contains elements from different data modalities using a common dimensional representation. This enables the system to process and reason over a variety of data types, facilitating complex tasks such as information extraction, content generation, or decision-making processes. The elements within input sequence 8, such as elements 8-0 through 8-9, can be processed by subsequent components of the system. For example, with reference to FIG. 9, the input sequence 8 from FIG. 10 can be processed with the prediction layer(s) 6, to generate an output sequence that can drive the generation of output(s) 3 based on the processed multimodal data.

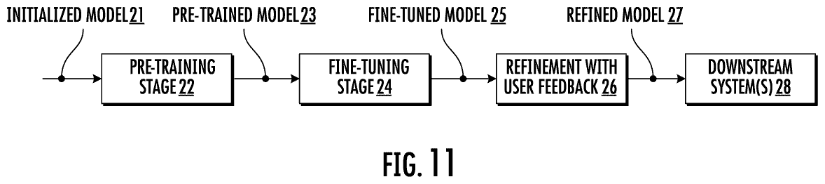

Referring now to FIG. 11, an example training flow for training a machine-learned model is depicted. The training flow illustrates the progression of a model through various stages, beginning with an initialized model 21 and culminating in a refined model 27 that can be output to downstream system(s) 28 for deployment or further development.

The initialized model 21 represents the starting point of the training process. This model can be in an initial state, with weight values that are either randomly assigned or based on an initialization schema. In some cases, the initial weight values can be derived from prior pre-training for the same or different models, providing a foundation upon which further training can be built.

The pre-training stage 22 signifies the initial phase of training, where the initialized model 21 undergoes large-scale training over potentially noisy data to achieve a broad base of performance levels across various tasks or data types. Pre-training stage 22 can be implemented using one or more pre-training pipelines that operate over data from dataset(s). This stage can be omitted if the initialized model 21 is already pre-trained, such as when the model contains, is, or is based on a pre-trained foundational model or an expert model.

Upon completion of the pre-training stage 22, the model transitions to a pre-trained model 23. This model can then undergo fine-tuning in the fine-tuning stage 24, where smaller-scale training is conducted on higher-quality data, such as labeled or curated datasets. Fine-tuning stage 24 can be facilitated by one or more fine-tuning pipelines, which refine the performance of pre-trained model 23 to meet specific performance criteria or to adapt to a narrower domain present in the fine-tuning dataset(s).

The fine-tuned model 25 represents the outcome of fine-tuning stage 24, which can then be subjected to refinement with user feedback 26. This stage involves incorporating feedback from human users to further enhance the model's performance. Refinement with user feedback 26 can include reinforcement learning techniques and can be based on human feedback on the model's performance during use.

The refined model 27 emerges from the refinement with user feedback 26 as an updated version of development model 16, which can then be output to downstream system(s) 28. Downstream system(s) 28 can be any system or platform where the refined model 27 is deployed for practical application or further development.

Overall, FIG. 11 provides a structured representation of the training flow for a machine-learned model, outlining the systematic approach to evolving the model from an initial state to a fully refined state ready for practical application or further development.

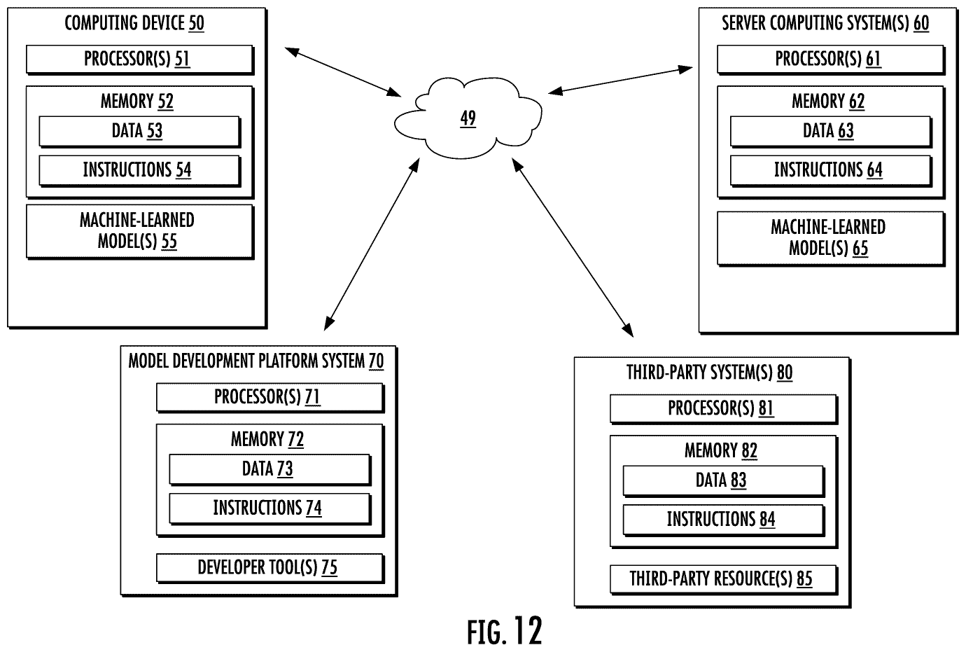

Referring now to FIG. 12, a block diagram is presented that illustrates an example networked computing system capable of performing various aspects of the disclosed machine learning-based image analysis techniques. The system includes a plurality of computing devices and systems that are interconnected via a network, facilitating cooperative interactions to execute the disclosed methods.

The example computing device 50 can represent a diverse range of computing devices, such as personal computing devices, mobile devices, or server computing devices. Computing device 50 includes one or more processors 51, which can be any suitable processing device such as a microprocessor or a controller. These processors 51 can execute data 53 and instructions 54 stored in memory 52 to perform operations that implement features of the present disclosure. Memory 52 can be a non-transitory computer-readable storage medium, such as RAM or flash memory devices.

Computing device 50 can also include machine-learned models 55, which can be loaded into memory 52 and utilized by processors 51 for various tasks, such as image analysis techniques as described herein. These machine-learned models 55 can be developed locally on computing device 50 or received from other systems like server computing system(s) 60.

Server computing system(s) 60 can mirror the structure of computing device 50, comprising processors 61 and memory 62 that store data 63 and instructions 64. Server computing system(s) 60 can also include machine-learned models 65, which can be the same as or different from machine-learned models 55 on computing device 50. These machine-learned models 65 can be used to host or serve model inferences for client devices, potentially implementing machine-learned models in a client-server relationship.

Network 49 serves as the communication medium that enables data exchange between computing device 50 and server computing system(s) 60. Network 49 can be any type of communications network, such as the internet, and can support various communication protocols and encodings to facilitate secure and efficient data transmission.

In some implementations, computing device 50 and server computing system(s) 60 can operate in a distributed computing environment, where server computing system(s) 60 manage the implementation of machine-learned models 65, and computing device 50 acts as a client device accessing the services provided by server computing system(s) 60. This configuration can allow for remote performance of inference and training operations, with outputs returned to computing device 50 for further use or analysis.

The server computing system(s) 60 and/or the computing device 50 can include and collaboratively operate to implement an application system as described herein which can include an image analysis application implemented via one or more machine-learned models and a thermal analyzer for thermal anomaly detection. For example, some or all of the application system can be implemented by the server computing system(s) 60. For example, the server computing system(s) 60 can implement the application system (including one or more of the image analysis application implemented via one or more machine-learned models and the thermal analyzer) as a web application or software as a service. Additionally, or alternatively, some or all of the application system can be implemented by the computing device 50. For example, the computing device 50 can implement the application system using locally stored and executed computer code (e.g., software). Thus, server computing system(s) 60 and/or the computing device 50 can include and execute computer instructions stored on computer-readable media to implement the systems and methods described herein.

The disclosed networked computing system exemplifies a versatile and scalable platform for implementing the advanced machine learning techniques described herein. By leveraging the interconnected nature of the computing devices and systems, the disclosed methods can be executed in a manner that optimizes resource utilization and maximizes the capabilities of the machine-learned models.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the disclosure is by way of example rather than by way of limitation, and the subject disclosure does not preclude inclusion of such modifications, variations or additions to the disclosure as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, numbers, steps, operations, elements, components, or combinations thereof.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A, (2) at least one of B, and (3) at least one of A and at least one of B. Likewise, the scope of the expression or phrase “at least one of A, B, or C” is intended to include all of the following: (1) at least one of A, (2) at least one of B, (3) at least one of C, (4) at least one of A and at least one of B, (5) at least one of A and at least one of C, (6) at least one of B and at least one of C, and (7) at least one of A, at least one of B, and at least one of C.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the disclosure.

To the extent terms including “module”, and “unit,” and the like are used herein, these terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blu-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

Each block of the flowchart illustrations may represent a unit, module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently (simultaneously) or the blocks may sometimes be executed in the reverse order, depending upon the functionality involved.

While the disclosure has been described with respect to various example embodiments, each example is provided by way of explanation, not limitation of the disclosure. Those skilled in the art, upon attaining an understanding of the foregoing, can readily produce alterations to, variations of, and equivalents to such embodiments. Accordingly, the disclosure does not preclude inclusion of such modifications, variations and/or additions to the disclosed subject matter as would be readily apparent to one of ordinary skill in the art. For example, features illustrated or described as part of one embodiment can be used with another embodiment to yield a still further embodiment. Thus, it is intended that the disclosure covers such alterations, variations, and equivalents.

What is claimed is:

1. A computer-implemented method, comprising:
obtaining, by a computing device comprising one or more processors, a visible light image which depicts a structure and a thermal image which depicts the structure;
implementing, by the computing device, one or more first machine-learned models to identify a class associated with the structure in the visible light image, based on the visible light image;
implementing, by the computing device, one or more second machine-learned models to identify one or more objects associated with the structure in the visible light image, based on the visible light image and the class associated with the structure;
determining, by the computing device, a temperature associated with each object among the one or more objects, based on the thermal image;
evaluating, by the computing device, for each object among the one or more objects, whether a temperature value associated with a respective object among the one or more objects satisfies a temperature criteria associated with the respective object; and
providing, by the computing device, an output based on the evaluating.

2. The computer-implemented method of claim 1, wherein the one or more first machine-learned models identify the class associated with the structure in the visible light image, based on the visible light image and the thermal image.

3. The computer-implemented method of claim 1, wherein the one or more second machine-learned models identify one or more objects in the visible light image, based on the visible light image, the thermal image, and the class associated with the structure.

4. The computer-implemented method of claim 1, wherein
the one or more first machine-learned models include an image classification model and the one or more second machine-learned models include an object detection model, and
the method further includes selecting the object detection model from among a plurality of object detection models based on the class identified by the image classification model.

5. The computer-implemented method of claim 1, wherein the temperature criteria is a threshold temperature value associated with the respective object.

6. The computer-implemented method of claim 1, wherein
the temperature value corresponds to a difference between a temperature of the respective object and an ambient temperature value, and
the temperature criteria is a threshold temperature difference value associated with the respective object.

7. The computer-implemented method of claim 6, wherein the ambient temperature value corresponds to one of a lowest maximum temperature among maximum temperatures of the one or more objects, a lowest temperature in the thermal image, or a value received via an input from a user providing the ambient temperature value.

8. The computer-implemented method of claim 1, further comprising:
blending, by the computing device, the visible light image and the thermal image to generate a blended image, wherein
implementing, by the computing device, the one or more first machine-learned models to identify the class associated with the structure in the visible light image, is based on the visible light image forming part of the blended image,
implementing, by the computing device, the one or more second machine-learned models to identify the one or more objects associated with the structure in the visible light image, is based on the visible light image forming part of the blended image and the class associated with the structure, and
determining, by the computing device, the temperature associated with each object among the one or more objects, is based on the thermal image forming part of the blended image.

9. The computer-implemented method of claim 1, wherein implementing, by the computing device, the one or more second machine-learned models to identify the one or more objects associated with the structure in the visible light image, based on the visible light image and the class associated with the structure, comprises:
providing at least one of a bounding shape or an indication of a key point to indicate a location of the respective object in at least one of the visible light image or the thermal image.

10. The computer-implemented method of claim 9, further comprising:
receiving an input changing a position of the bounding shape or the indication of the key point to indicate a changed location of the respective object in the at least one of the visible light image or the thermal image; and
updating the one or more second machine-learned models based on the input.

11. The computer-implemented method of claim 1, further comprising determining a priority level of each of the one or more objects based on the temperature value of each respective object among the one or more objects, a respective weight value associated with the temperature value, and a number of objects identified in the visible light image via the one or more second machine-learned models, and
wherein providing, by the computing device, the output is further based on the priority level of each of the one or more objects.

12. The computer-implemented method of claim 1, further comprising:
determining a priority level of each of the one or more objects based on the temperature value of each respective object among the one or more objects;
determining an overall priority level associated with the thermal image and the visible light image; and
providing, by the computing device, the output is further based on the overall priority level in comparison to overall priority levels associated with other thermal images and other visible light images.

13. The computer-implemented method of claim 1, wherein
the visible light image includes a plurality of objects,
the temperature value corresponds to a difference between a temperature of a first object among the plurality of objects and a second object among the plurality of objects, and
the temperature criteria is a threshold temperature difference value associated with a difference in temperatures among the plurality of objects.

14. The computer-implemented method of claim 1, wherein
a plurality of objects are associated with the structure,
implementing, by the computing device, the one or more second machine-learned models to identify the plurality of objects associated with the structure in the visible light image, based on the visible light image and the class associated with the structure, comprises identifying a first object, a second object, and a third object connecting the first object and the second object, and
the third object is associated with a first temperature criteria different from a second temperature criteria associated with the first object and the second object.

15. The computer-implemented method of claim 1, wherein the visible light image and the thermal image are captured at substantially a same time and from substantially a same perspective view.

16. The computer-implemented method of claim 1, further comprising performing an image registration operation by mapping a first set of coordinates associated with the one or more objects in the visible light image to a second set of coordinates associated with the one or more objects in the thermal image, and
determining, by the computing device, the temperature associated with each object among the one or more objects, based on the thermal image, comprises determining a temperature associated with the second set of coordinates associated with the one or more objects in the thermal image.

17. The computer-implemented method of claim 1, wherein in response to the evaluating indicating a temperature value associated with at least one object does not satisfy the temperature criteria, providing, by the computing device, the output based on the evaluating comprises generating a notification indicating the at least one object requires servicing.

18. The computer-implemented method of claim 1, wherein in response to the evaluating indicating a temperature value associated with at least one object does not satisfy the temperature criteria, providing, by the computing device, the output based on the evaluating comprises automatically implementing a remedial or preventive action with respect to the at least one object.

19. The computer-implemented method of claim 1, further comprising:
determining a confidence value associated with each of the one or more objects, and
in response to a confidence value of at least one object being less than a threshold value, prompting a user to adjust at least one parameter associated with at least one of the visible light image or the thermal image.

20. A computing device, comprising:
one or more memories configured to store instructions; and
one or more processors configured to execute the instructions to perform operations, the operations comprising:
obtaining a visible light image which depicts a structure and a thermal image which depicts the structure,
implementing one or more first machine-learned models to identify a class associated with the structure in the visible light image, based on the visible light image,
implementing one or more second machine-learned models to identify one or more objects associated with the structure in the visible light image, based on the visible light image and the class associated with the structure,
determining a temperature associated with each object among the one or more objects, based on the thermal image,
evaluating for each object among the one or more objects, whether a temperature value associated with a respective object among the one or more objects satisfies a temperature criteria associated with the respective object, and
providing an output based on the evaluating.

21. A non-transitory computer readable medium storing instructions which, when executed by a processor, cause the processor to perform operations, the operations comprising:
obtaining a visible light image which depicts a structure and a thermal image which depicts the structure,
implementing one or more first machine-learned models to identify a class associated with the structure in the visible light image, based on the visible light image,
implementing one or more second machine-learned models to identify one or more objects associated with the structure in the visible light image, based on the visible light image and the class associated with the structure,
determining a temperature associated with each object among the one or more objects, based on the thermal image,
evaluating for each object among the one or more objects, whether a temperature value associated with a respective object among the one or more objects satisfies a temperature criteria associated with the respective object, and
providing an output based on the evaluating.
